(19) United States
(12) Patent Application Publication
(10) Pub. No.: US 2014/0225925 A1
(43) Pub. Date: Aug. 14, 2014

(54) INFORMATION PROCESSING DEVICE AND STORAGE MEDIUM

(71) Applicant: SONY CORPORATION, Tokyo (JP)

(72) Inventors: KAZUNORI HAYASHI, Tokyo (JP); TAKAYASU KON, Tokyo (JP); YASUNORI KAMADA, Kanagawa (JP); YOICHIRO SAKO, Tokyo (JP); TAKATOSHI NAKAMURA, Tokyo (JP)

(73) Assignee: SONY CORPORATION, Tokyo (JP)

(21) Appl. No.: 14/157,419

(22) Filed: Jan. 16, 2014

(30) Foreign Application Priority Data
Feb. 14, 2013 (JP) 2013-026465

(51) Int. Cl. G09G 5/36

(52) U.S. Cl. CPC G09G 5/36
USPC 345/634

(57) ABSTRACT

There is provided an information processing device including a classification unit configured to classify content data into any of a plurality of classification items based on a first attribute, a priority level determination unit configured to determine a priority level to the content data classified by the classification unit for each of the classification items based on a second attribute, a selection unit configured to select one of the content data for each of the classification items according to the priority level determined by the priority level determination unit based on a third attribute, and a generation unit configured to generate a display image having a symbol image arranged therein, the symbol image being corresponded to the content data selected by the selection unit and being arranged in the display image for each of the classification items in a layout according to the first attribute.

### CROSS REFERENCE TO RELATED APPLICATIONS

This application claims the benefit of Japanese Priority Patent Application JP 2013-026465 filed Feb. 14, 2013, the entire contents of which are incorporated herein by reference.

### BACKGROUND

The present disclosure relates to an information processing device and a storage medium.

In the past, a user had access to a desired image by causing images such as still images or moving images captured and accumulated by a digital camera or the like to be displayed as a list view in the order of imaging date. However, in recent years, the amount of captured images is becoming enormous with the spread of a terminal having camera functions and the increase in storage capacity, and thus there is a tendency that it becomes difficult to access a desired image from among a large number of images by relying on only an image-captured date. In a lifelogging camera that can be worn on the body of its user to continuously capture every minute of situation all day, such a trend is particularly pronounced, because it is unconscious of the image-captured date unlike the case of active capturing. Thus, a technique for providing a user interface capable of easily accessing a desired image from among a large number of images has been developed.

For example, in JP 2007-122431A, disclosed is a technique for distributing and displaying photos for each classification item on a two-dimensional classification plane composed of two classification axes selected from year, month, day of week or the like, under consideration that the photos are captured at the timing of regular or periodic events such as holiday or birthday.

Furthermore, in JP 2010-250448A, disclosed is a technique for searching for photos using two parameters selected from location, time, animals or the like and displaying searched photos for each classification item on a two-dimensional classification plane composed of two classification axes corresponding to two selected parameters.

### SUMMARY

As described above, in recent years, the amount of captured images is becoming enormous with the spread of a terminal having camera functions and the increase in storage capacity, and thus further improvement in the performance of a technology for easily accessing a desired image is necessary.

Therefore, embodiments of the present disclosure provide a novel and improved information processing device and storage medium capable of classifying content data based on an attribute, selecting content data suitable for each classification item, and generating a display image that displays the selected content data as a list view.

According to an embodiment of the present disclosure, there is provided an information processing device including a classification unit configured to classify content data into any of a plurality of classification items based on a first attribute, a priority level determination unit configured to determine a priority level to the content data classified by the classification unit for each of the classification items based on a second attribute, a selection unit configured to select one of the content data for each of the classification items according to the priority level determined by the priority level determination unit based on a third attribute, and a generation unit configured to generate a display image having a symbol image arranged therein, the symbol image being corresponded to the content data selected by the selection unit and being arranged in the display image for each of the classification items in a layout according to the first attribute.

According to an embodiment of the present disclosure, there is provided a non-transitory computer-readable storage medium having a program stored therein, the program causing a computer to execute classifying content data into any of a plurality of classification items based on a first attribute, determining a priority level to the classified content data for each of the classification items based on a second attribute, selecting one of the content data for each of the classification items according to the priority level based on a third attribute, and generating a display image having a symbol image arranged therein, the symbol image being corresponded to the selected content data and being arranged in the display image for each of the classification items in a layout according to the first attribute.

According to one or more of embodiments of the present disclosure, it is possible to classify content data based on an attribute, select content data suitable for each classification item, and generate a display image that displays the selected content data as a list view.

### BRIEF DESCRIPTION OF THE DRAWINGS

FIG. 1 is a diagram for explaining an overview of an information processing device according to an embodiment of the present disclosure;

FIG. 2 is a diagram for explaining an algorithm for generating a list view screen by the information processing device according to an embodiment of the present disclosure;

FIG. 3 is a block diagram illustrating the configuration of a tablet terminal according to an embodiment of the present disclosure;

FIG. 4 is a diagram illustrating an overview of the operation of a tablet terminal according to an embodiment of the present disclosure;

FIG. 5 is a diagram illustrating an example of a list view screen of a tablet terminal according to an embodiment of the present disclosure;

FIG. 6 is a flowchart illustrating the operation of a tablet terminal according to an embodiment of the present disclosure;

FIG. 7 is a flowchart illustrating the operation of a tablet terminal according to an embodiment of the present disclosure;

FIG. 8 is a flowchart illustrating the operation of a tablet terminal according to an embodiment of the present disclosure;

FIG. 9 is a flowchart illustrating the operation of a tablet terminal according to an embodiment of the present disclosure;

FIG. 10 is a flowchart illustrating the operation of a tablet terminal according to an embodiment of the present disclosure;

FIG. 11 is a diagram illustrating an example of a search range input screen of a tablet terminal according to an embodiment of the present disclosure;

FIG. 12 is a diagram illustrating an example of an attribute input screen of a tablet terminal according to an embodiment of the present disclosure;

FIG. 13 is a diagram illustrating an example of an attribute input screen of a tablet terminal according to an embodiment of the present disclosure;

FIG. 14 is a diagram illustrating an example of a detail view screen of a tablet terminal according to an embodiment of the present disclosure;

FIG. 15 is a diagram illustrating an example of a list view screen of a tablet terminal according to Application Example 1;

FIG. 16 is a diagram illustrating an example of a list view screen of a tablet terminal according to Application Example 2;

FIG. 17 is a diagram illustrating an example of a list view screen of a tablet terminal according to Application Example 3; and

FIG. 18 is a diagram illustrating an example of a list view screen of a tablet terminal according to Application Example 4.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

1. Overview of Information Processing Device according to Embodiment of the Present Disclosure

2. Embodiment of the Present Disclosure
2-1. Configuration of Tablet Terminal
2-2. Operation Process
2-3. Application Examples

3. Summary

### 1. Overview of Information Processing Device according to Embodiment of the Present Disclosure

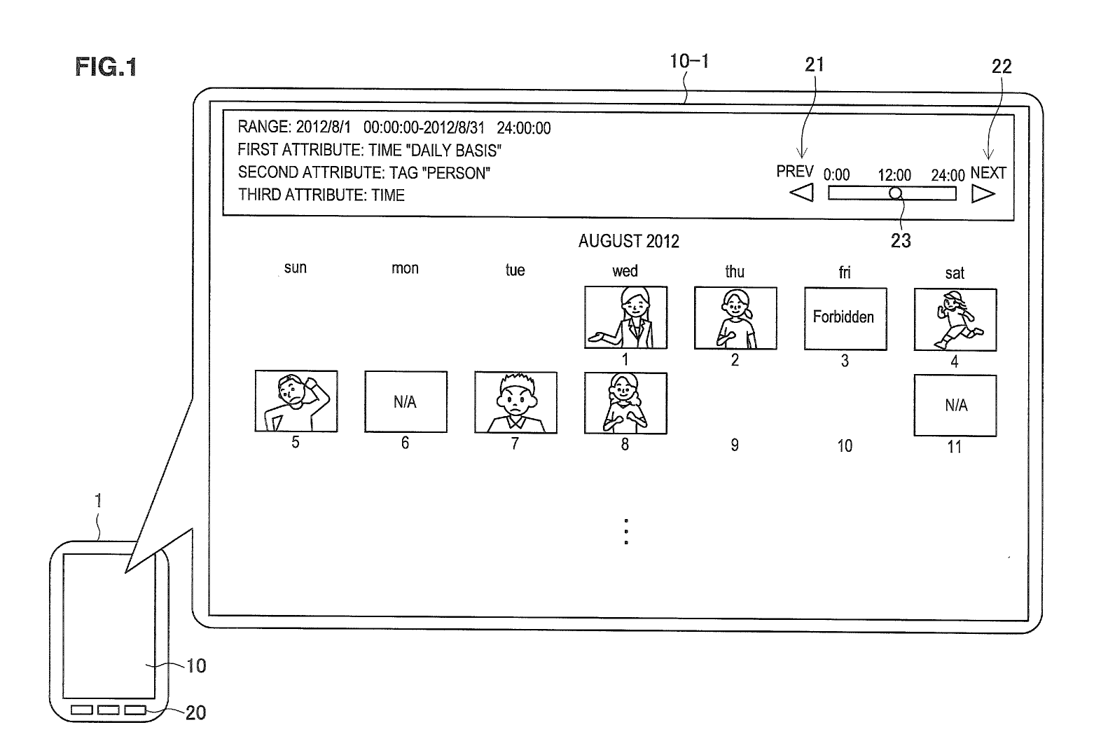

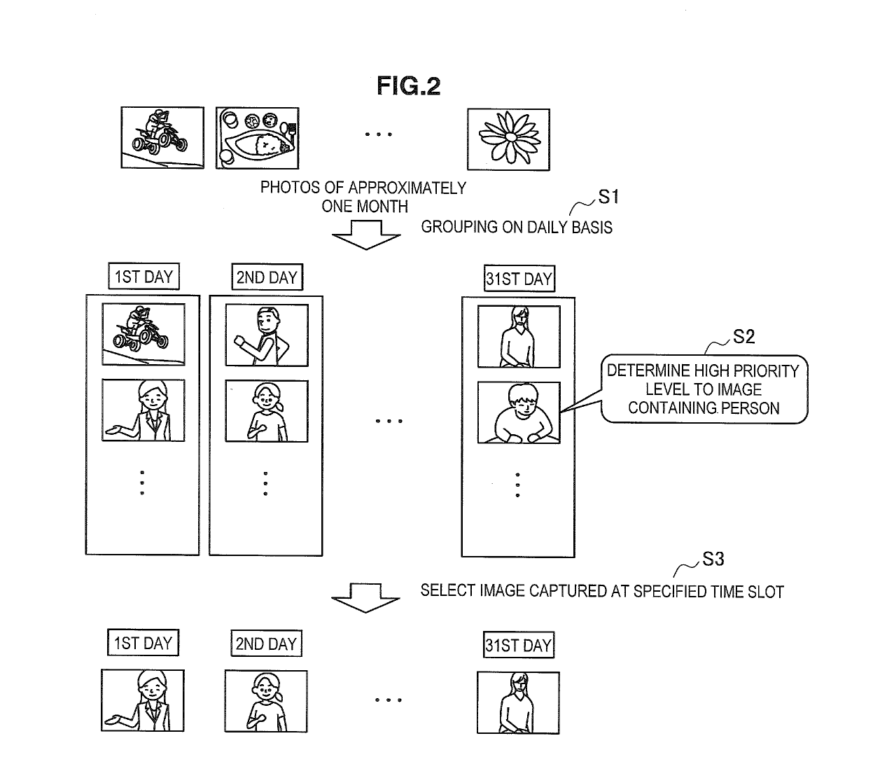

An overview of an information processing device according to an embodiment of the present disclosure will be described with reference to FIGS. 1 and 2. FIG. 1 is a diagram for explaining an overview of the information processing device according to an embodiment of the present disclosure. As illustrated in FIG. 1, the information processing device according to the present embodiment is implemented, as an example, by a tablet terminal 1.

The tablet terminal 1 includes a display unit 10 and an input unit 20, and causes the display unit 10 to display an image to a user. The tablet terminal 1 can store a large number of images, such as still images or moving images (content data), which are captured by an imaging unit (not shown) or obtained from an information processing device such as a lifelogging camera. The tablet terminal 1 can display a display image as a list view screen 10-1. The display image displays a plurality of thumbnails (symbol images) indicating an image selected from among a large number of images at once as shown in FIG. 1.

The list view screen 10-1 displays thumbnails of an image that contains a person from among images captured during the period of from 2012/8/1 00:00:00 to 2012/8/31 24:00:00 and is captured around the time of 12:00. The thumbnails are displayed as a list view in a calendar form once a day. The user selects a thumbnail included in the list view screen 10-1 by means of the input unit 20, and thus can access an image corresponding to the selected thumbnail.

As illustrated in FIG. 1, the tablet terminal 1 displays a thumbnail marked “Forbidden” (browsing is prohibited) for an image in which browsing prohibition is set by the user, as the date of August 3. Furthermore, if there is no image containing a person captured at a specified time as the date of August 6 or 11, then the tablet terminal 1 displays a thumbnail marked “N/A” (not available). In addition, if there is no image captured at a certain day, then the tablet terminal 1 leaves a thumbnail corresponding to the day as a blank, as shown at the date of August 9 or 10.

In this regard, as an example, it is assumed that a user wants to access an image of a person and the user remembered the fact that the image has been captured around the time of 12:00 but forgot the captured date of the image. In such a situation, thumbnails indicating an image that contains a person and is captured around the time of 12:00 are displayed as a list view in a calendar form on a list view screen 10-1, and thus the user can easily access a desired image from among thumbnails displayed as a list view.

The user specifies a plurality of conditions in order to cause such list view screen 10-1 to be displayed on a display unit 10. More specifically, initially, a first attribute, a second attribute, and a third attribute are specified. The first attribute is a criterion for classifying images into a plurality of groups (classification items), the second attribute is a criterion for determining a priority level of each image classified into each group, and the third attribute is a criterion for selecting an image to be displayed as a thumbnail. In the example shown in FIG. 1, the user specifies the time “daily basis” as the first attribute, specifies a tag “person” as the second attribute, and specifies “time” as the third attribute.

The user then specifies an attribute value of the third attribute, and thus can cause the display unit 10 to display a list view screen in which a thumbnail corresponding to the specified attribute value is placed. The attribute value of the third attribute is the specific contents of the third attribute. In the example shown in FIG. 1, the attribute value of the third attribute is an imaging time. The user can specify the time by operating the position of an operating unit 23 in a bar corresponding to the time. In the example shown in FIG. 1, the user specifies the time of 12:00. The user can move the position of the operating unit 23 to the left or right of the bar by operating a PREV key 21 or a NEXT key 22, and thereby changing a time to be specified back and forth. An algorithm in which the tablet terminal 1 generates the list view screen 10-1 will be described below with reference to FIG. 2.

FIG. 2 is a diagram for explaining an algorithm in which the information processing device according to an embodiment of the present disclosure generates the list view screen 10-1. As illustrated in FIG. 2, the tablet terminal 1 generates the list view screen 10-1 by the algorithm including three steps. It is assumed that the tablet terminal 1 generates the list view screen 10-1 shown in FIG. 1 for images captured during a period of approximately one month from Aug. 1 to Aug. 31, 2012.

As illustrated in FIG. 2, initially, in step S1, the tablet terminal 1 classifies images captured during a period of approximately one month into any of a plurality of groups on a daily basis, i.e., August 1, 2, . . . , 31, based on the first attribute.

Next, in step S2, the tablet terminal 1 determines a high priority level to an image containing a person from among images classified into each group, based on the second attribute. More specifically, the tablet terminal 1 determines a high priority level to an image tagged with (associated with) a keyword “person” for each group. The image is tagged with a keyword indicating the contents of an image such as a person, animal, or plant. In addition, the tablet terminal 1 determines a low priority level to an image to which a tag indicating a keyword “person” is not attached.

Subsequently, in step S3, the tablet terminal 1 selects one image captured around the specified time of 12:00 for each group according to the priority level based on the third attribute. More specifically, the tablet terminal 1 selects one image captured around the time of 12:00 for each day between August 1 and August 31 from among images to which a tag of a person is attached.

The tablet terminal 1 then generates the list view screen 10-1 in which thumbnails corresponding to an image selected daily according to such an algorithm are placed in a calendar form that is a layout corresponding to the time “daily basis” that is the first attribute. Subsequently, the tablet terminal 1 displays the list view screen 10-1 on the display unit 10.

In the above, the algorithm in which the tablet terminal 1 generates the list view screen 10-1 shown in FIG. 1 has been described.

As described above, JP 2007-122431A and JP 2010-250448A disclose a technique in which images are classified by means of two parameters or classification axes and the images are each displayed for each classification item. However, in none of JP 2007-122431A and JP 2010-250448A is there any mention with regard to the selective display of an image suitable for each classification item. In contrast, the information processing device according to an embodiment of the present disclosure can display an image for each classification item as a list view. The image to be displayed has a high priority level and has a high probability of being an image desired by the user that corresponds to the attribute value of the third attribute. Thus, the user can find out a desired image at a glance from among thumbnails displayed as a list view.

Furthermore, the information processing device according to an embodiment of the present disclosure displays a thumbnail for each classification item in a layout corresponding to the first attribute, thus the user can find a desired image while tracing back his memory along the layout corresponding to the first attribute. For example, in the example shown in FIG. 1, the tablet terminal 1 places thumbnails in a calendar form, and thus the user browses the thumbnails and then can find out a desired image while remembering what day of the week an image was captured, what action the user has taken on the previous and next days, or the like.

Moreover, the information processing device according to an embodiment of the present disclosure can switch all thumbnails at once in response to the user operation. Thus, even when a desired image is not included in the list view screen 10-1, the user can easily find out the desired image while switching all thumbnails at once.

For example, it is assumed that there is no image desired by the user among thumbnails included in the list view screen 10-1 shown in FIG. 1. In such a case, the user can change the time specified as an attribute value of the third attribute back and forth by operating the operating unit 23, the PREV key 21, or the NEXT key 22 shown in FIG. 1, thereby updating the list of thumbnails. In this case, all thumbnails from August 1 to August 31 are updated to thumbnails of an image captured at the time after the change. Thus, even when a desired image is not included in the list view screen 10-1, the user can find out the desired image while updating the list of thumbnails by changing the time to be specified back and forth. In addition, an image that has a low priority level or is not captured at the specified time, that is, a thumbnail having a low probability of being an image desired by the user is not included in the list view screen after the update. Accordingly, the user can find out a desired image while checking thumbnails having a high probability of being an image desired by the user sequentially without browsing all of the large number of images.

The overview of the information processing device according to an embodiment of the present disclosure has been described above. Subsequently, the details of the information processing device according to an embodiment of the present disclosure will be described.

In the example shown in FIG. 1, the tablet terminal 1 is used as one example of the information processing device, but the information processing device according to an embodiment of the present disclosure is not limited thereto. For example, the information processing device may include HMD (Head Mounted Display), digital cameras, digital video cameras, PDAs (Personal Digital Assistants), PCs (Personal Computers), laptop/notebook PCs, smartphones, mobile phone terminals, portable audio players, portable media players, or handheld game consoles.

### 2. Embodiment of the Present Disclosure

### 2-1. Configuration of Tablet Terminal

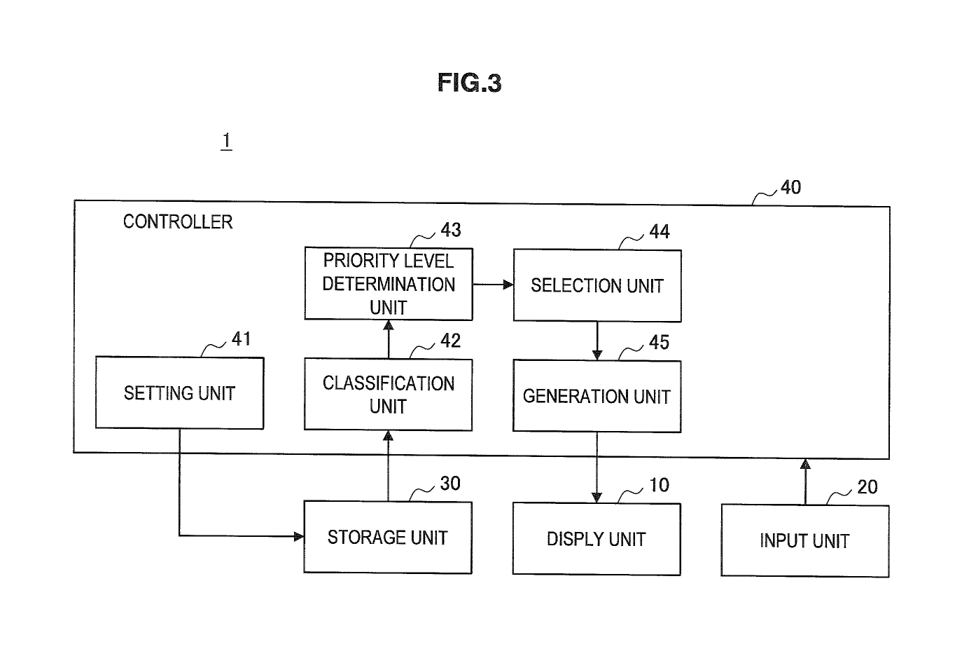

A configuration of the tablet terminal 1 according to the present embodiment will now be described with reference to FIG. 3. FIG. 3 is a block diagram illustrating a configuration of the tablet terminal 1 according to an embodiment of the present disclosure. As shown in FIG. 3, the tablet terminal 1 includes the display unit 10, the input unit 20, a storage unit 30, and a controller 40. Each component of the tablet terminal 1 will now be described in detail.

(Display Unit)

The display unit 10 displays an image under the control of the controller 40. The display unit 10 displays the image generated by a generation unit 45 that will be described later. The display unit 10 is implemented by, for example, LCD (Liquid Crystal Display), OLED (Organic Light-Emitting Diode), or the like.

(Input Unit)

The input unit 20 has a function of receiving an input by the user. The input unit 20 receives an input that indicates the specifications of the first attribute, the second attribute, the third attribute, and the specification or change of an attribute value of the third attribute. In the example shown in FIG. 1, the input unit 20 receives an input for specifying an attribute value of the third attribute by allowing the user to operate the operating unit 23, the PREV key 21, or the NEXT key 22. Moreover, the input unit 20 receives selection of a thumbnail to access an image, setting of browsing prohibition, or the like. The input unit 20 is implemented by, for example, a touch panel which is formed integrally with the display unit 10, buttons, a microphone for voice input, or the like.

(Storage Unit)

The storage unit 30 stores an image that is captured by an imaging unit (not shown) or is obtained from an information processing device such as other PCs. The storage unit 30 stores an image along with an EXIF (Exchangeable image file format) file. The EXIF file stores, for example, information that indicates imaging date, imaging location, or imaging conditions. In addition, the storage unit 30 stores setting information that contains a tag indicating the contents of an image such as a person, animal or plant, the setting of browsing prohibition, or the like in an attribute file associated with the image. The setting information is set by a setting unit 41 that will be described later. The storage unit 30 may store the setting information in association with the image by embedding the setting information into the EXIF file. The tag that indicates the contents of an image may be automatically set by an image analysis process of the controller 40 or may be set by the user. Moreover, the tag may be set by marking at the time of imaging. For example, the storage unit 30 is implemented by, for example, a magnetic recording medium such as hard disk, or a nonvolatile memory such as flash memory.

(Controller)

The controller 40 functions as an operation processing device and a control device, and controls the overall operation of the tablet terminal 1 according to various programs. The controller 40 is implemented by, for example, CPU (Central Processing Unit), or microprocessor. In addition, the controller 40 may be configured to include a ROM (Read Only Memory) for storing a program or operation parameter to be used and a RAM (Random Access Memory) for temporarily storing a parameter or the like that is varied appropriately.

The controller 40 according to the present embodiment generates a list view screen in which an image selected based on the first, second and third attributes is arranged in a layout corresponding to the first attribute. In addition, the controller 40 functions as a setting unit 41, a classification unit 42, a priority level determination unit 43, a selection unit 44, and a generation unit 45.
Setting Unit

The setting unit 41 sets browsing prohibition for an image stored in the storage unit 30. Moreover, the setting unit 41 sets an image stored in the storage unit 30 by using a keyword indicating the contents of the image as a tag. The setting unit 41 may set the browsing prohibition or tag based on the user input received by the input unit 20, or may automatically set the browsing prohibition or tag by an image analysis process.
Classification Unit

The classification unit 42 classifies an image into any of a plurality of groups based on the first attribute. The first attribute is a criterion for classifying an image as described above and has a property that is repeated for each unit. The first attribute may include, for example, weekly basis, monthly basis, yearly basis, every weekday, every holiday, or the like, in addition to the daily basis shown in FIG. 1. If the first attribute is related to time, the classification unit 42 performs classification based on an imaging date. Furthermore, the first attribute may include a unit indicating a geographical range such as five hundred meters square, one kilometers square, or the like. If the first attribute is related to the geographical range, the classification unit 42 performs classification based on an imaging location.
Priority Level Determination Unit

The priority level determination unit 43 determines a priority level for each group to an image classified by the classification unit 42 based on the second attribute. The second attribute is a criterion for determining a priority level of the image classified into each group as described above. The second attribute may include, for example, a keyword such as a tag “person” as shown in FIG. 1. The priority level determination unit 43 determines a priority level based on a keyword associated with an image. For example, the priority level determination unit 43 determines a high priority level to an image tagged with a keyword such as “person”, “animal”, or “plant” specified as the second attribute. The priority level determination unit 43 determines a low priority level to an image that is not tagged with a specified keyword. Further, the second attribute includes, for example, a feature value of an image. If the second attribute is the feature value of an image, the priority level determination unit 43 determines a priority level according to the specified feature value. For example, if the second attribute is a feature value of “yellow”, the priority level determination unit 43 determines a high priority level to an image having a larger number of yellow pixels, but determines a low priority level to an image having a smaller number of yellow pixels. Furthermore, the priority level determination unit 43 may determine a priority level depending on whether the image is captured actively or the image is captured automatically.

Note that there may be provided a plurality of the second attributes. For example, if a tag “person” and time “07:00-09:00” are specified as the second attribute, the priority level determination unit 43 determines a high priority level to an image that is tagged with a keyword “person” and has an imaging time from 07:00 to 09:00.
Selection Unit

The selection unit 44 selects one image for each group according to the priority level determined by the priority level determination unit 43 based on the third attribute. The third attribute is a criterion for selecting an image that indicates a thumbnail as described above. The selection unit 44 selects an image corresponding to an attribute value specified as the attribute value of the third attribute.

The third attribute includes, for example, time (imaging time). The selection unit 44 selects an image captured (obtained) at the time specified as an attribute value or around the specified time for each group according to a priority level. As shown in FIG. 1, if the second attribute is a tag “person” and the time of 12:00 is specified as an attribute value of the third attribute, the selection unit 44 selects an image that contains a person on a daily basis and is captured around the time of 12:00. In this case, the selection unit 44 may select an image captured at the time of 12:00 exactly. In addition, the attribute value of the third attribute may be specified as the range of time. For example, if the attribute value of the third attribute is specified as the time ranging from 12:00 to 13:00, the selection unit 44 may select an image captured during the time ranging from 12:00 to 13:00 exactly, or the selection unit 44 may select an image captured during the time ranging from before 12:00 until after 13:00. Moreover, the attribute value of the third attribute may be specified as the time using a keyword. For example, if the attribute value of the third attribute is “lunch time”, the selection unit 44 may select an image captured during the time ranging from 12:00 to 13:00 exactly, based on, for example, rules of employment of the user's work place. In addition, for example, if the attribute value of the third attribute is “lunch time slot or before bedtime”, the selection unit 44 may select an image captured during the time ranging from before 12:00 until after 13:00 or from before 22:00 until after 23:00. If there is no image obtained at the time specified as an attribute value or around the specified time, the selection unit 44 may not select an image. In this case, as described later, a thumbnail marked “N/A” (not available) is placed by the generation unit 45.

Furthermore, the third attribute includes, for example, a feature value of an image. The selection unit 44 selects an image having the feature value specified as an attribute value for each group according to a priority level. For example, if the third attribute is the feature value of “yellow”, the selection unit 44 selects an image having the feature value in which yellow pixels are specified as an attribute value for each group according to a priority level. If there is no image having the feature value specified as the attribute value, the selection unit 44 may not select an image. In this case, as described later, a thumbnail marked “N/A” (not available) is placed by the generation unit 45. Note that the image selected by the selection unit 44 will be referred hereafter to as a candidate image.

The selection unit 44 may select one candidate image from among images having a higher priority level than a threshold based on the third attribute. In other words, the selection unit 44 may perform filtering on candidates of an image selected as a candidate image based on the priority level. For example, in the example shown in FIG. 1, the selection unit 44 selects a candidate image from among images tagged with a keyword “person”, but the selection unit 44 does not select a candidate image from among images that are not tagged with a keyword “person”.

Moreover, if the input unit 20 receives an input for changing the attribute value of the third attribute, the selection unit 44 reselects one candidate image for each group according to the priority level based on the changed attribute value of the third attribute. For example, in the example shown in FIG. 1, if the time to be specified is changed from 12:00 to 13:00, the selection unit 44 reselects an image that contains a person and is captured around the time of 13:00.

In order for the selection unit 44 to easily reselect a candidate image according to the change in the attribute value of the third attribute, the controller 40 may rearrange images for each group and give the order of selection to each image. The order of selection is the order indicating a sequence of images to be selected when the selection unit 44 selects an image. The order of selection is used to more finely determine the sequence for images having the same priority level based on the second attribute. For example, if the third attribute is time, the controller 40 rearranges images determined to have the same priority level for each group in the order of imaging time, and thus gives the order of selection to the images in the order of imaging time. In addition, if the third attribute is a feature value, the controller 40 rearranges images determined to have the same priority level for each group in the order of images that contains more feature values, and thus gives the order of selection to the images in the order of images that contains more feature values.

The user then specifies the order of selection as an attribute value of the third attribute. For example, in the case where the third attribute is the feature value, if the user specifies the 1st order of selection, the selection unit 44 selects an image that contains the greatest number of feature values. In addition, when the PREV key 21 or the NEXT key 22 is operated, the selection unit 44 reselects an image arranged in front of or behind the image on which a thumbnail is currently being displayed, that is, an image having a lower or higher order of selection. For example, if the third attribute is time, the selection unit 44 selects an image having the imaging time directly preceding or following the image on which a thumbnail is currently being displayed. In addition, if the third attribute is the feature value, the selection unit 44 selects an image having the next larger or smaller feature values than the image on which a thumbnail is currently being displayed.

Generation Unit

The generation unit 45 generates a list view screen (display image) in which a thumbnail corresponding to a candidate image selected by the selection unit 44 is placed for each group in a layout according to the first attribute. For example, if the first attribute is time, more specifically, a daily basis as shown in FIG. 1, then the generation unit 45 generates a list view screen in which thumbnails are placed in a position corresponding to the date when a candidate image is obtained on a background image representing a calendar. Further, if the first attribute is time, more specifically, a minutely basis, then the generation unit 45 generates a list view screen in which thumbnails are placed in a position corresponding to the time when a candidate image is obtained on a background image representing a clock face. In addition, if the first attribute is position information, more specifically, a unit indicating a geographical range, the generation unit 45 generates a list view screen in which thumbnails are placed in a position corresponding to a position where a candidate image is obtained on a background image representing a map.

Furthermore, in the case where the input unit 20 receives an input for changing the attribute value of the third attribute and selection unit 44 reselects a candidate image, the generation unit 45 regenerates a list view screen by using the candidate image reselected by the selection unit 44. In this way, the thumbnail placed in the list view screen displayed by the display unit 10 is updated to a thumbnail according to the changed attribute value.

Moreover, the generation unit 45 can place a thumbnail that displays the fact that browsing is prohibited in a distinguishable manner to a candidate image prohibited from browsing. For example, as the date of August 3 shown in FIG. 1, if the candidate image selected by the selection unit 44 is prohibited from browsing, the generation unit 45 places a thumbnail marked “Forbidden” that indicates that browsing is prohibited, instead of the thumbnail corresponding to the candidate image.

In addition, the generation unit 45 can generate a list view screen that displays, in a distinguishable manner, a group in which none of the images would not classified by the classification unit 42 and a group in which one or more images are classified but an image that match a specified condition is not classified.

In other words, the generation unit 45 does not place any thumbnail to a group in which none of the images is classified by the classification unit 42. For example, as the date of August 9 or 10 shown in FIG. 1, the date when none of the images is captured is represented as a blank.

On the other hand, the generation unit 45 places a thumbnail marked “N/A” (not available) to a group in which an image corresponding to the attribute value of the third attribute is not classified. In this case, the thumbnail marked “N/A” indicates that there is no image satisfying the condition. For example, as the date of August 6 or 11 shown in FIG. 1, if there is an image captured at other time but no image captured at the time of 12:00, the generation unit 45 places a thumbnail marked “N/A” (not available). Further, the generation unit 45 may generate a list view screen in which the thumbnail marked “N/A” (not available) is placed to a group in which an image having a higher priority level than a threshold is not classified. In this case, the thumbnail marked “N/A” indicates that there is no image satisfying the condition. For example, in the example shown in FIG. 1, the generation unit 45 places the thumbnail marked “N/A” (not available) to the date when there is no image tagged with a keyword “person”.

(Supplement)

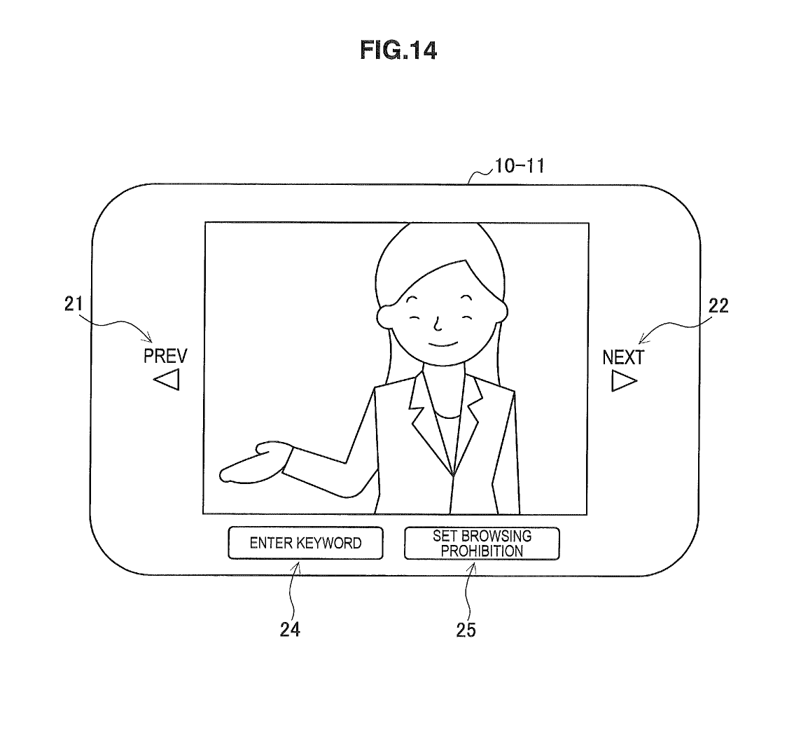

If a thumbnail displayed as a list view on a list view screen is selected by the user operation, the generation unit 45 generates a detail view screen (see FIG. 14 described later) that displays an image corresponding to the selected thumbnail as a detail view. In the detail view screen, the input unit 20 can receive an input for changing the attribute value of the third attribute for the image displayed as a detail view. In this case, the selection unit 44 reselects one image according to a priority level based on the changed attribute value from among images classified in the same manner as a group into which the image displayed as a detail view is classified (contained). The generation unit 45 then regenerates a detail view screen (display image) in which the image displayed as a detail view is changed to the image reselected by the selection unit 44. When the detail view screen is completed, the generation unit 45 regenerates a list view screen in which the thumbnail selected by the user operation is updated to a thumbnail indicating the image reselected by the selection unit 44.

Furthermore, in the case where a thumbnail displayed as a list view on a list view display is selected the user operation, the generation unit 45 may display a screen that displays, as a list view, an image corresponding to the thumbnail and an image having an imaging time close to the image corresponding to the thumbnail. This screen makes it possible for the user to find out a desired image and images captured at the time before and after the desired image, in a sequential manner. For example, it is assumed that the user wants an image captured at an event such as travelling or banquet and the image captured at the event is included in a list view screen. In such a case, the image described above is more likely to be one image among a plurality of images captured at the event. Thus, the user can display images captured at the time before and after thereof as a list view, thereby finding out images captured at the event in a sequential manner.

The configuration of the tablet terminal 1 according to the present embodiment has been described above.

### 2-2. Operation Process

(Operation Process: Overview)

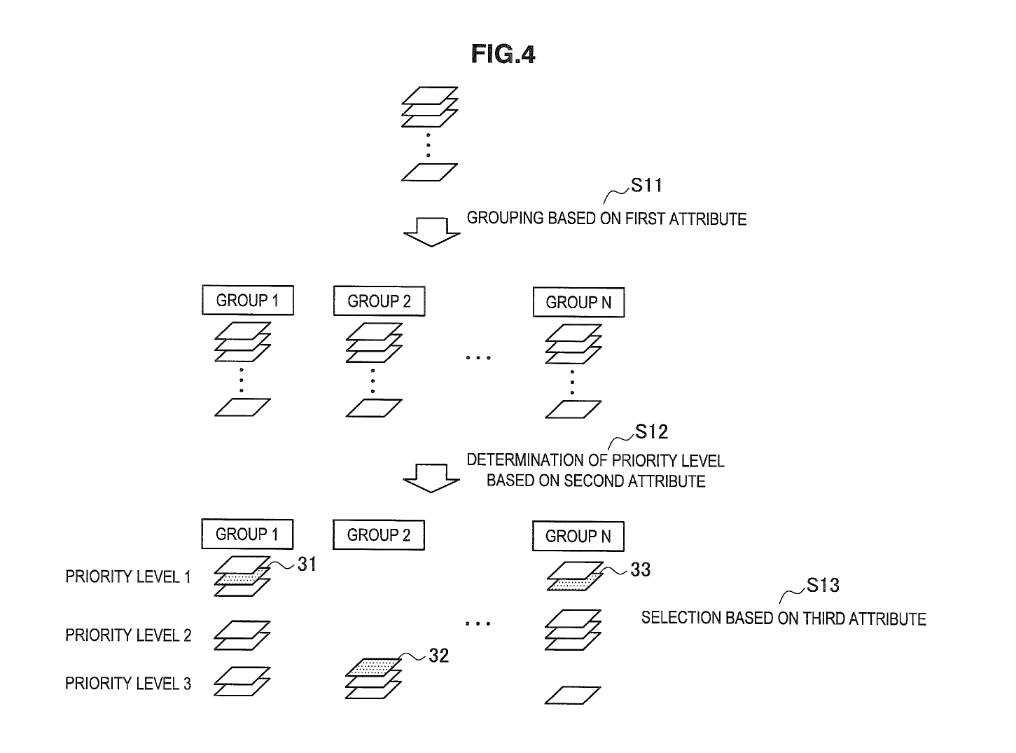

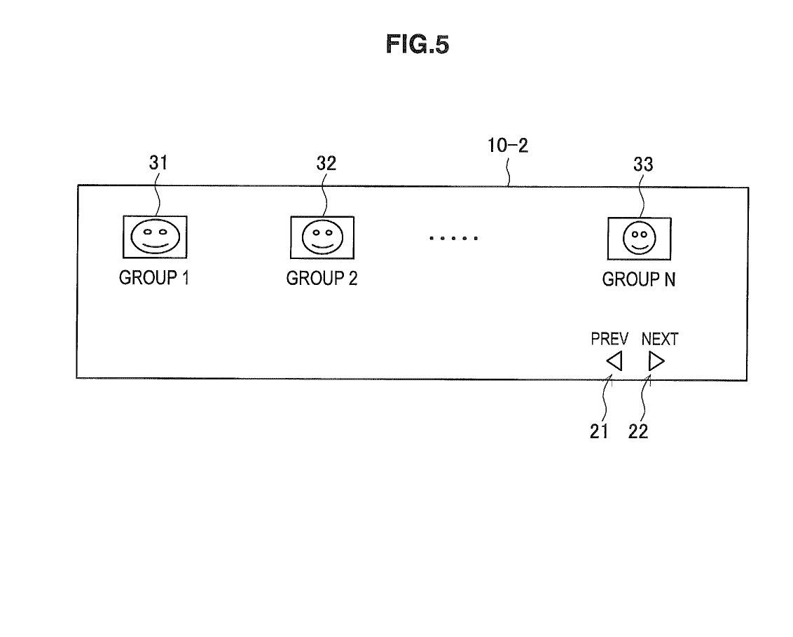

Subsequently, an overview of the operation process of the tablet terminal 1 according to the present embodiment will be described with reference to FIGS. 4 and 5. FIG. 4 is a diagram illustrating an overview of the operation of the tablet terminal 1 according to an embodiment of the present disclosure.

As shown in FIG. 4, initially, in step S11, the classification unit 42 classifies an image into any of N groups based on the first attribute. Next, in step S12, the priority level determination unit 43 determines a priority level for each of N groups to an image classified by the classification unit 42 based on the second attribute. Subsequently, in step S13, the selection unit 44 selects an image, which is assigned with the highest priority level and corresponds to the specified attribute value of the third attribute, for each group as a candidate image. For example, in FIG. 4, the selection unit 44 selects an image 31 for Group 1, an image 32 for Group 2, and an image 33 for Group N.

The generation unit 45 then generates a list view screen in which thumbnails corresponding to a candidate image selected by the selection unit 44 are placed for each group in a layout according to the first attribute. An example of the list view screen generated by the generation unit 45 is illustrated in FIG. 5. FIG. 5 is a diagram illustrating an example of a list view screen of the tablet terminal 1 according to an embodiment of the present disclosure. As shown in FIG. 5, the generation unit 45 generates a list view screen 10-2 in which the images 31, 32 and 33 selected by the selection unit 44 in step S13 of FIG. 4 are placed in Groups 1, 2 and N, respectively.

Moreover, when the PREV key 21 or the NEXT key 22 is selected by the user, the selection unit 44 reselect a candidate image by changing the attribute value of the third attribute, and the generation unit 45 updates a thumbnail according to the reselected candidate image.

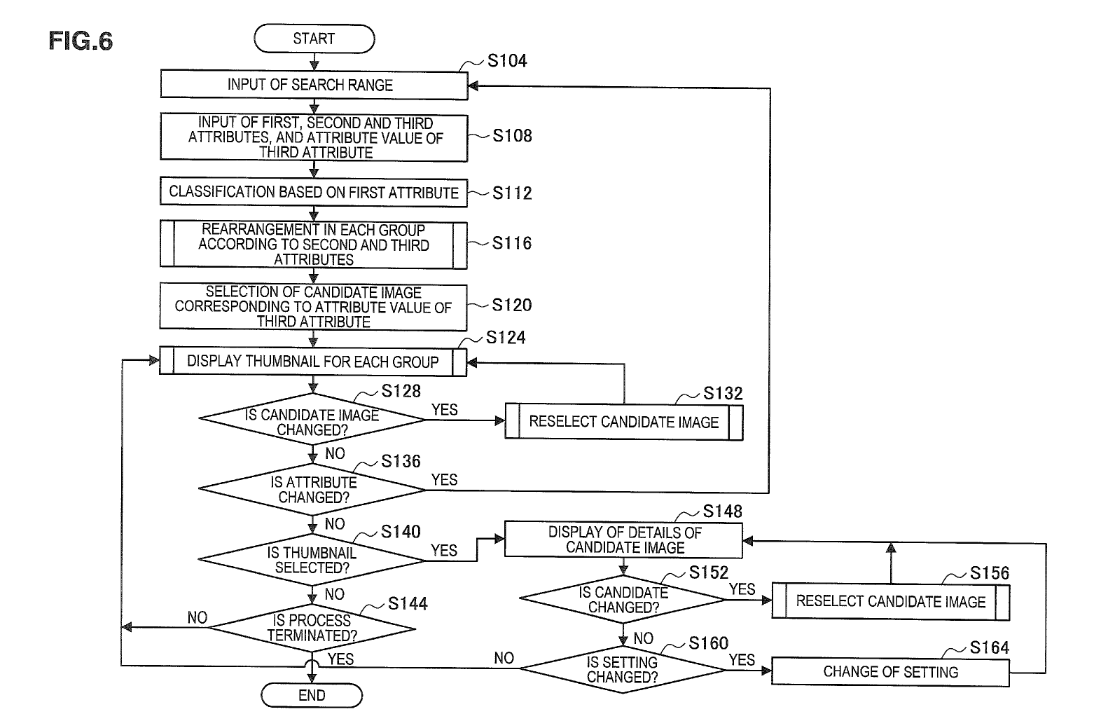

An overview of the operation of the tablet terminal 1 has been described above. Subsequently, the operation of the tablet terminal 1 will be described in detail with reference to FIGS. 6 to 14.

(Operation Process: Overall Processing)

FIGS. 6 to 10 are flowcharts illustrating the operation of the tablet terminal 1 according to an embodiment of the present disclosure. As shown in FIG. 6, initially, in step S104, the input unit 20 receives an input of a search range used to limit a range to be displayed as a list view.

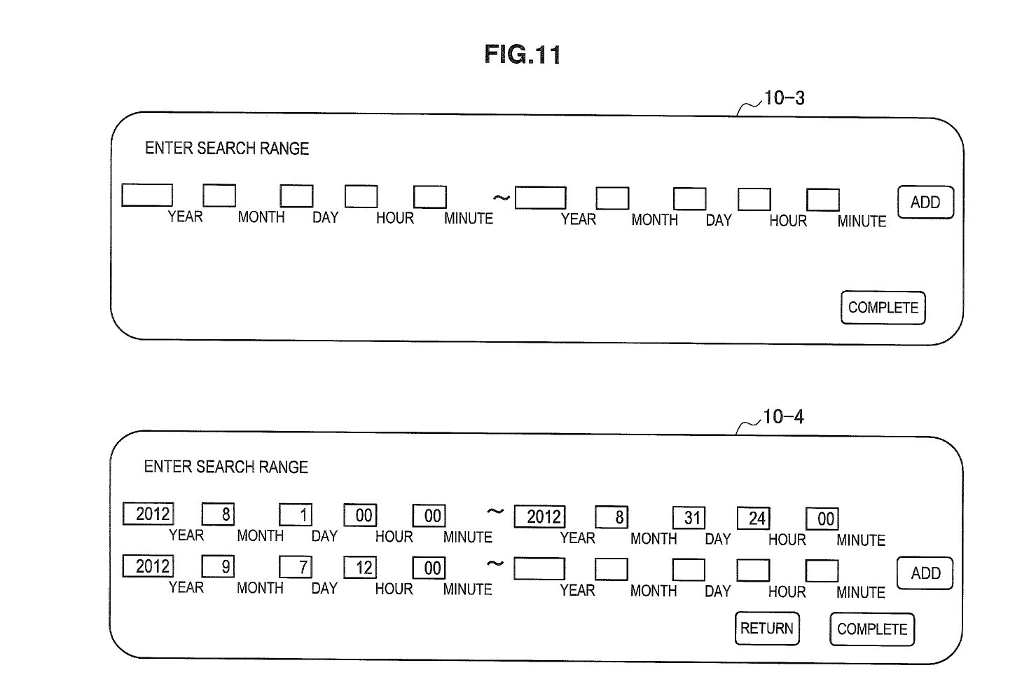

For example, the input unit 20 receives an input of a search range in a search range input screen 10-3 shown in FIG. 11. FIG. 11 is a diagram illustrating an example of a search range input screen of the tablet terminal 1 according to an embodiment of the present disclosure. As shown in FIG. 11, in the search range input screen 10-3, the user specifies the range of an imaging time of interest by entering year, month, day, hour, and minute. In the example shown in FIG. 1, the input unit 20 receives an input for setting a search range to a period of time from 2012-08-01 00:00:00 to 2012-08-31 24:00:00. The user shifts from the search range input screen 10-3 to a search range input screen 10-4 by selecting “ADD” key in the search range input screen 10-3, thereby specifying the range of a plurality of imaging times.

Next, in step S108, the input unit 20 receives an input of the first, second and third attributes, and an attribute value of the third attribute. For example, in the example shown in FIG. 1, the input unit 20 receives an input for specifying a time “daily basis” as the first attribute, a tag “person” as the second attribute, a “time” as the third attribute, and a time of 12:00 at the attribute value of the third attribute.

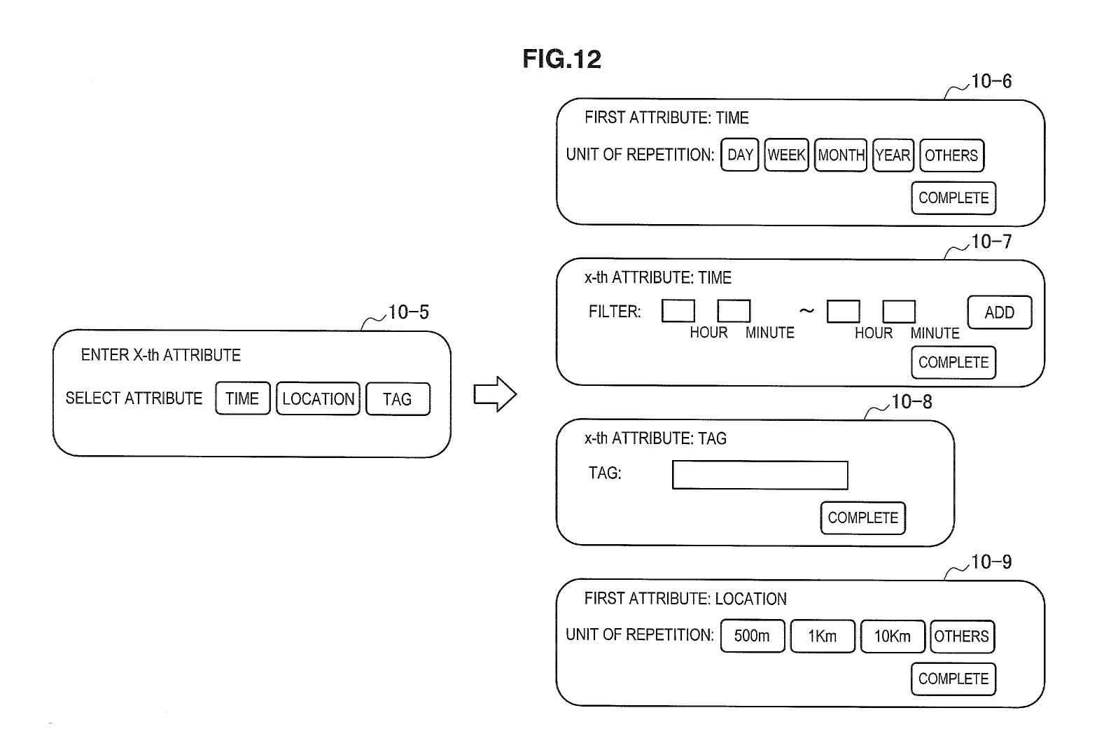

In this case, for example, the user enters the respective attributes in attribute input screens 10-5 to 10-9 shown in FIG. 12. FIG. 12 is a diagram illustrating an example of an attribute input screen of the tablet terminal 1 according to an embodiment of the present disclosure. As shown in FIG. 12, the user can select a desired attribute in the attribute input screen 10-5.

If a “time” is selected as the first attribute in the attribute input screen 10-5, the screen is shifted to an attribute input screen 10-6, and thus the user can specify a daily basis, a weekly basis, a monthly basis, or other units as a unit of repetition. In addition, if a “time” is selected as the second or third attribute in the attribute input screen 10-5, the screen is shifted to an attribute input screen 10-7, and thus the user can specify the range of a desired imaging time.

Further, if a “tag” is selected as the second or third attribute in the attribute input screen 10-5, the screen is shifted to an attribute input screen 10-8, and thus the user can enter a desired keyword.

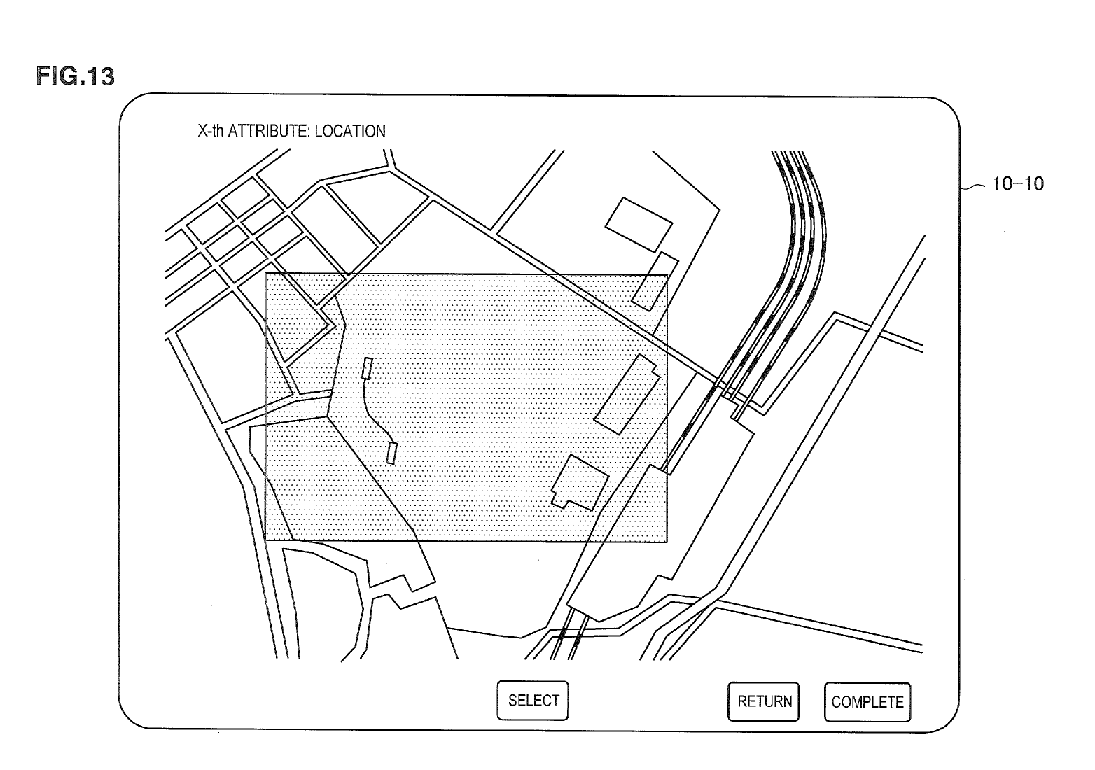

Furthermore, if a “location” is selected as the first attribute in the attribute input screen 10-5, the screen is shifted to an attribute input screen 10-9, and thus the user can specify five hundred meters square, one kilometers square, ten kilometers square, or other units as a unit of repetition. In addition, if a “location” is selected as the second or third attribute in the attribute input screen 10-5, the screen is shifted to an attribute input screen 10-10 shown in FIG. 13. FIG. 13 is a diagram illustrating an example of an attribute input screen of the tablet terminal 1 according to an embodiment of the present disclosure. As shown in FIG. 13, the user can specify the range of an imaging location by specifying a range on a map image in the attribute input screen 10-10.

The description is continued by referring back to the flowchart shown in FIG. 6. Subsequent to step S108, in step S112, the classification unit 42 classifies an image included in a search range based on the first attribute. For example, in the example shown in FIG. 1, the classification unit 42 classifies an image captured during a period of time from 2012-08-01 00:00:00 to 2012-08-31 24:00:00 into a total of thirty-one groups which corresponds to a daily basis specified as the first attribute.

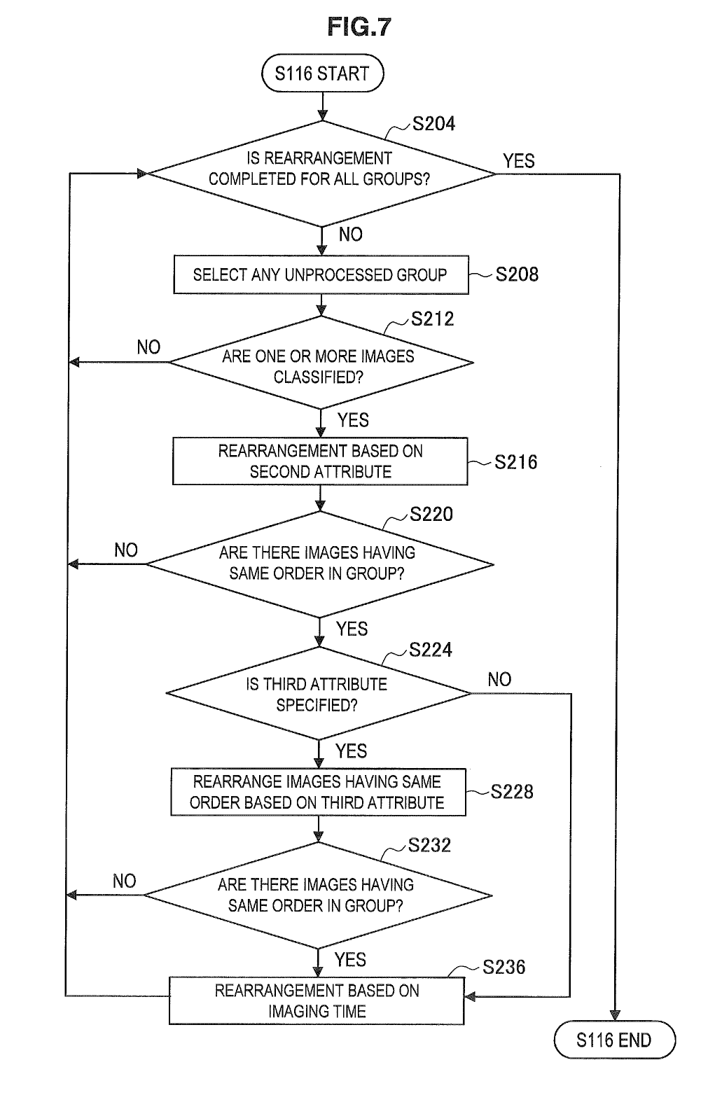

Next, in step S116, the controller 40 rearranges an image classified into each group according to the second and third attributes. The process in step S116 will be described later with reference to FIG. 7, and thus the detailed description thereof is omitted here.

Subsequently, in step S120, the selection unit 44 selects a candidate image corresponding to the attribute value of the third attribute. For example, in the example shown in FIG. 1, the selection unit 44 selects an image captured around the time of 12:00 for each group from among images rearranged in the above-described step S116.

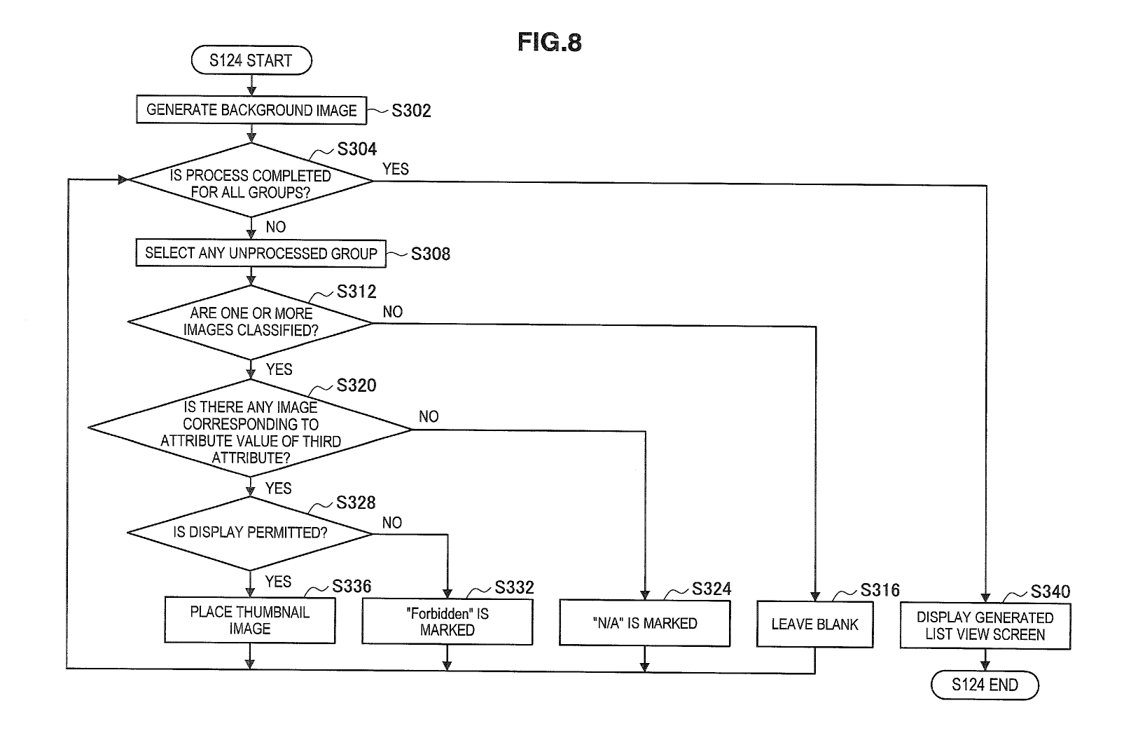

Then, in step S124, the display unit 10 displays a list view screen in which a thumbnail indicating the candidate image selected by the selection unit 44 for each group is placed. The process in step S124 will be described later with reference to FIG. 8, and thus the detailed description thereof is omitted here.

Subsequently, in step S128, the controller 40 determines whether the input unit 20 receives an input for instructing the change of the candidate image. For example, in the example shown in FIG. 1, the controller 40 determines whether any one of the operation unit 23, the PREV key 21, and the NEXT key 22 is operated.

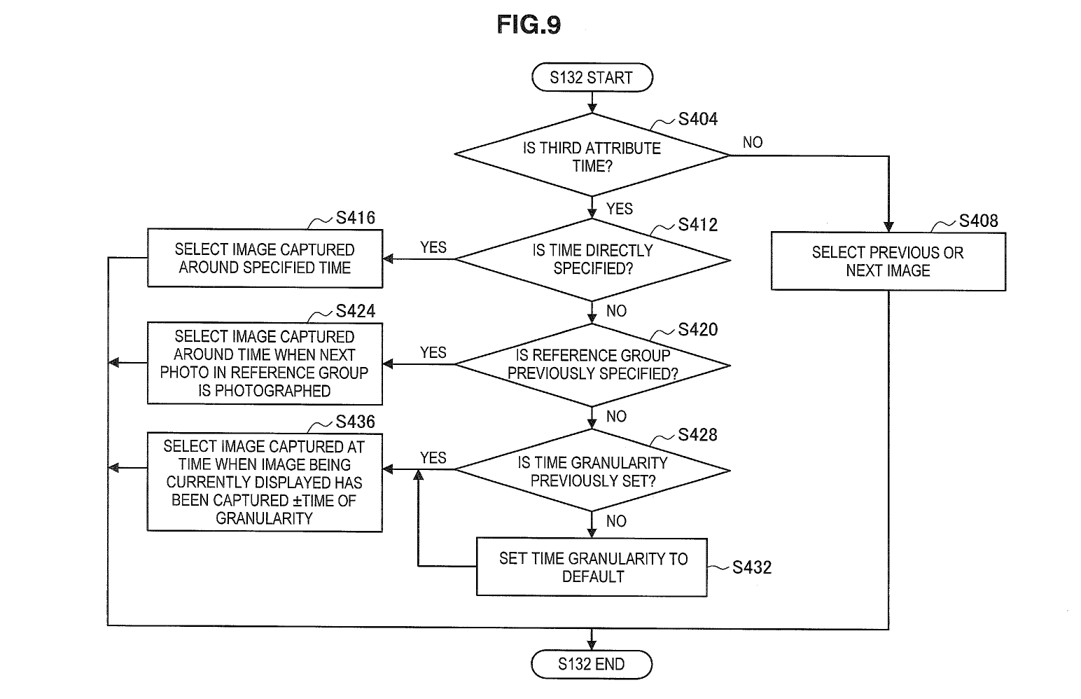

If it is determined that the input unit 20 receives an input for instructing the change of a candidate image (YES in step S128), then, in step S132, the selection unit 44 reselects a candidate image. The process in step S132 will be described later with reference to FIG. 9, and thus the detailed description thereof is omitted here.

On the other hand, if it is determined that the input unit 20 does not receive an input for instructing the change of a candidate image (NO in step S128), then, in step S136, the controller 40 determines whether the input unit 20 receives an input for instructing the change of an attribute.

If it is determined that the input unit 20 receives an input for instructing the change of an attribute (YES in step S136), then the process returns to step S104.

On the other hand, if it is determined that the input unit 20 does not receive an input for instructing the change of an attribute (NO in step S136), then, in step S140, the controller 40 determines whether the input unit 20 receives an input for instructing the selection of a thumbnail.

If it is determined that the input unit 20 does not receive an input for instructing the selection of a thumbnail (NO in step S140), then, in step S144, the controller 40 determines whether the input unit 20 receives an input for instructing termination of the process.

If it is determined that the input unit 20 receives an input for instructing termination of the process (YES in step S144), then the process is terminated. On the other hand, if it is determined that the input unit 20 does not receive an input for instructing termination of the process (NO in step S144), then the process returns to step S124.

Moreover, in step S140 described above, if it is determined that the input unit 20 receives an input for instructing the selection of a thumbnail (YES in step S140), then, in step S148, the display unit 10 displays details of a candidate image corresponding to the selected thumbnail. For example, in the example shown in FIG. 1, if the thumbnail on August 1 is selected, the display unit 10 displays a detail view screen 10-11 shown in FIG. 14.

FIG. 14 is a diagram illustrating an example of a detail view screen of the tablet terminal 1 according to an embodiment of the present disclosure. As shown in FIG. 14, a candidate image corresponding to the thumbnail on August 1 in FIG. 1 is displayed in an enlarged manner on the detail view screen 10-11. In addition, the PREV key 21, the NEXT key 22, a setting key 24, and a setting key 25 are arranged in the detail view screen 10-11. The user can set the browsing prohibition or withdrawal to the candidate image by selecting the setting key 24. In addition, the user can enter a keyword and cause the candidate image to be tagged with the keyword, by selecting the setting key 25.

Subsequently, in step S152, the controller 40 determines whether the input unit 20 receives an input for instructing the change of a candidate image. For example, in the detail view screen 10-11 shown in FIG. 14, the controller 40 determines whether any one of the PREV key 21 and NEXT key 22 is selected.

If it is determined that the input unit 20 receives an input for instructing the change of a candidate image (YES in step S152), then, in step S156, the selection unit 44 reselects a candidate image in a similar way as step S132 described above. Then, the process returns to step S148, and the display unit 10 displays a detail view screen for the reselected candidate image.

On the other hand, if it is determined that that the input unit 20 does not receive an input for instructing the change of a candidate image (NO in step S152), then, in step S160, the controller 40 determines whether the input unit 20 receives an input for instructing the change of settings. For example, in the detail view screen 10-11 shown in FIG. 14, the controller 40 determines whether any one of the setting key 24 and the setting key 25 is selected.

If it is determined that the input unit 20 receives an input for instructing the change of settings (YES in step S160), then, in step S164, the controller 40 changes settings for the candidate image displayed as a detail view in accordance with the instruction received by the input unit 20. For example, the controller 40 causes the candidate image to be tagged with a keyword entered by the user, or sets browsing prohibition or withdrawal. Then, the process returns to step S148 described above.

On the other hand, if it is determined that the input unit 20 does not receive an input for instructing the change of settings (NO in step S160), then the process returns to step S124 described above. In this case, after the lapse of a predetermined period of time from the time that the detail view screen is displayed or when there is an instruction for terminating the detail view screen by the user, the controller 40 may control the process to return to step S124.

In the above, the overall processing of the operation process performed by the tablet terminal 1 has been described.

(Operation Process: Step S116)

Subsequently, referring to FIG. 7, a description will be given of the detailed operation process in step S116 described above. As shown in FIG. 7, initially, in step S204, the controller 40 determines whether the rearrangement for all groups is completed.

If it is determined that the rearrangement is completed (YES in step S204), then the process in step S116 is terminated.

On the other hand, if it is determined that the rearrangement is not completed (NO in step S204), then, in step S208, the controller 40 selects any unprocessed group.

Subsequently, in step S212, the controller 40 determines whether one or more images are classified in the selected group by the classification unit 42.

If it is determined that one or more images are not classified (NO in step S212), then the process returns to step S204. In this case, the controller 40 regards rearrangement for the selected group as being completed, and then the controller 40 regards the process as being terminated.

On the other hand, if it is determined that one or more images are classified (YES in step S212), then, in step S216, the controller 40 performs rearrangement based on the second attribute. More specifically, the controller 40 performs rearrangement of images classified into groups to be arranged in order from an image having a high priority level determined by the priority level determination unit 43. In the example shown in FIG. 1, the controller 40 performs rearrangement of images so that the images are arranged in the order of an image tagged with a keyword “person” specified as the second attribute and then an image that is not tagged with “person”.

Subsequently, in step S220, the controller 40 determines whether there are images having the same order of selection in a group. More specifically, the controller 40 determines whether there are images determined to have the same priority level in a group.

If it is determined that there are no images having the same order of selection in a group (NO in step S220), then the process returns to step S204 described above. In this case, the controller 40 regards rearrangement for the selected group as being completed, and then the controller 40 regards the process as being terminated.

On the other hand, if it is determined that there are images having the same order of selection in a group (YES in step S220), then, in step S224, the controller 40 determines whether the third attribute is specified.

If it is determined that the third attribute is not specified (NO in step S224), then, in step S236, the controller 40 rearranges images having the same order of selection in a group, i.e., having the same priority level to be arranged in the order of imaging time. The controller 40 then updates the order of selection to follow the rearranged rank.

On the other hand, if it is determined that the third attribute is specified (YES in step S224), then, in step S228, the controller 40 performs rearrangement based on the third attribute. More specifically, the controller 40 performs rearrangement of images having the same order of selection in a group, i.e., having the same priority level, based on the attribute value of the third attribute. In the example shown in FIG. 1, a “time” is specified as the third attribute, and thus the controller 40 rearranges images tagged with a keyword “person” in the order of imaging time and then rearranges images that are not tagged with a keyword “person” in the order of imaging time. The controller 40 then updates the order of selection to follow the rearranged rank.

Subsequently, in step S232, the controller 40 determines whether there are images having the same order of selection in a group.

If it is determined that there are no images having the same order of selection in a group (NO in step S232), then the process returns to step S204 described above. In this time, the controller 40 regards a process for the selected group as being terminated.

On the other hand, if it is determined that there are images having the same order of selection in a group (YES in step S232), then, in step S236, the controller 40 performs rearrangement of images having the same order of selection in a group in the order of imaging time. The controller 40 then updates the order of selection to follow the rearranged rank.

Subsequently, the process returns to step S204 described above. In this case, the controller 40 regards the process for the selected group as being terminated.

In the above, the detailed operation process in step S116 has been described.

(Operation Process: Step S124)

Subsequently, referring to FIG. 8, a description will be given of the detailed operation process in step S124 described above. As shown in FIG. 8, initially, in step S302, the generation unit 45 generates a background image of a layout according to the first attribute. For example, in the example shown in FIG. 1, the generation unit 45 generates a background image in a calendar form as a layout according to the time “daily basis” that is the first attribute.

Next, in step S304, the controller 40 determines whether the process for all groups is completed.

If it is determined that the process is not completed (NO in step S304), then, in step S308, the controller 40 selects any unprocessed group.

Subsequently, in step S312, the controller 40 determines whether one or more images are classified in the selected group by the classification unit 42.

If it is determined that one or more images are not classified (NO in step S312), then, in step S316, the generation unit 45 does not place any thumbnail for the group and leaves it as a blank. For example, in the example shown in FIG. 1, for the date when there is no image being captured, none of the thumbnails is placed and is left blank. In this case, the controller 40 regards the process that places thumbnails for the selected groups as being completed, and thus regards the process as being terminated.

On the other hand, if it is determined that one or more images are classified (YES in step S312), then, in step S320, the controller 40 determines whether there is any image corresponding to the attribute value of the third attribute. More specifically, the controller 40 determines whether an image corresponding to the attribute value of the third attribute is selected by the selection unit 44.

If it is determined that there is no image corresponding to the attribute value of the third attribute (NO in step S320), then, in step S324, the generation unit 45 places the thumbnail marked “N/A” (not available) in the group. For example, in the example shown in FIG. 1, if there no image captured around the time of 12:00 specified as the attribute value of the third attribute, the thumbnail marked “N/A” (not available) is placed. In addition, even if an image having a higher priority level than a threshold is not classified based on the second attribute, the generation unit 45 places the thumbnail marked “N/A” (not available). For example, in the example shown in FIG. 1, if there is no image tagged with a “person” specified as the second attribute, the thumbnail marked “N/A” (not available) is placed. In this case, the controller 40 regards the process for the selected group is terminated.

On the other hand, if it is determined that there is an image corresponding to the attribute value of the third attribute (YES in step S320), then, in step S328, the controller 40 determines whether the image is permitted to be displayed. More specifically, the controller 40 determines whether browsing prohibition is set to the image.

If it is determined that the image is not permitted to be displayed (NO in step S328), that is, the browsing prohibition is set, then, in step S332, the generation unit 45 places a thumbnail marked “Forbidden” (browsing is prohibited) in the group. In this case, the controller 40 regards the process for the selected group as being terminated.

On the other hand, if it is determined that the image is permitted to be displayed (YES in step S328), that is, when browsing prohibition is not set, then, in step S336, the generation unit 45 places a thumbnail of the image that corresponds to the attribute value of the third attribute and is selected by the selection unit 44 in the group. In this case, the controller 40 regards the process for the selected group as being terminated.

If it is determined that the processes described above are completed for all groups (YES in step S304), then, in step S340, the display unit 10 displays a list view screen in which a thumbnail is placed for each group. This list view screen is generated by the generation unit 45.

In the above, the detailed operation process in step S124 has been described.

(Operation Process: Step S132)

Subsequently, referring to FIG. 9, the operation process in step S132 described above will now be described in detail. As shown in FIG. 9, initially, in step S404, the controller 40 determines whether the third attribute is time.

If it is determined that the third attribute is not time (NO in step S404), then, in step S408, the selection unit 44 selects a previous or next image. More specifically, the selection unit 44 selects an image having a lower or higher order of selection.

On the other hand, if it is determined that the third attribute is time (YES in step S404), then, in step S412, the controller 40 determines whether the time is directly specified as the attribute value of the third attribute.

If it is determined that the time is directly specified (YES in step S412), then, in step S416, the generation unit 45 selects an image captured around the specified time.

On the other hand, if it is determined that the time is not directly specified (NO in step S412), then, in step S420, the controller 40 determines whether a reference group is previously specified. In this case, the reference group is a group that serves as a reference for switching thumbnails and is specified in advance by the user.

If it is determined that the reference group is previously specified (YES in step S420), then, in step S424, an image captured around the time when a next or later image in the reference group is captured is selected. More specifically, the selection unit 44, initially, selects the previous or next image in the reference group. Subsequently, the selection unit 44 selects an image captured around the imaging time of the image selected in the reference group from a group other than the reference group.

On the other hand, if it is determined that the reference group is not previously specified (NO in step S420), then, in step S428, the controller 40 determines whether time granularity is previously set. In this case, the time granularity indicates the amount of variation in the imaging time when thumbnails are switched, and is previously set by the user.

If it is determined that the time granularity is not previously set (NO in step S428), then, in step S432, the controller 40 sets the time granularity to a default value.

On the other hand, if it is determined that the time granularity is previously set (YES in step S428), then, in step S436, the selection unit 44 selects an image captured at the time obtained by addition (+) of the time indicated by the time granularity to the time when the image being currently displayed has been captured and by subtraction (−) of the time indicated by the time granularity from the time when the image being currently displayed has been captured. More specifically, the selection unit 44, as an image having a higher order of selection, selects an image captured at the time obtained by subtraction (−) of the time indicated by the time granularity from the time when the image being currently displayed has been captured, and, as an image having a lower order of selection, selects an image captured at the time obtained by addition (+) of the time indicated by the time granularity to the time when the image being currently displayed has been captured.

In the above, the detailed operation process in step S132 has been described.

(Operation Process: Automatic Tagging)

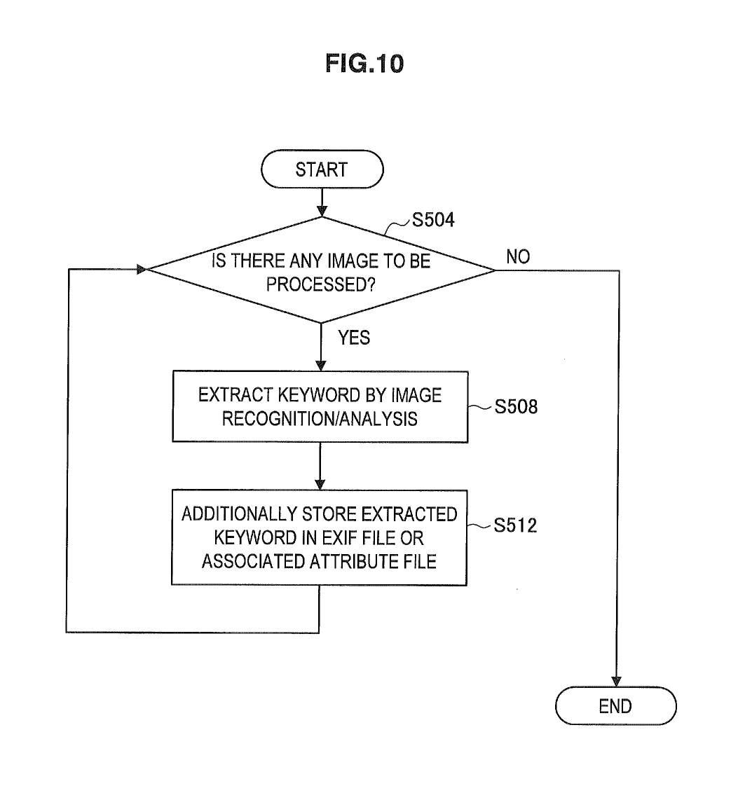

Subsequently, referring to FIG. 10, a process in which the setting unit 41 automatically tags a keyword that indicates the contents of an image will now be described. As shown in FIG. 10, initially, in step S504, the setting unit 41 determines whether there is any image to be processed. For example, when an imaging unit (not shown) captures a new image or when a new image is obtained from another information processing device, the setting unit 41 determines that there is an image to be processed.

If it is determined that there is no image to be processed (NO in step S504), then the process ends. On the other hand, if it is determined that there is an image to be processed (YES in step S504), then, in step S508, the setting unit 41 extracts an keyword that indicates the contents of an image by means of image recognition or image analysis. For example, if there is an image contains a person, then “person” is extracted. In addition, if there is an image contains a plant, then “plant” is extracted.

Then, in step S512, the setting unit 41 additionally stores the extracted keyword in an EXIF file or an attribute file associated with the image. In this case, the extracted and additionally stored keyword may be provided as a plurality of keywords.

In the above, the process in which the setting unit 41 automatically tags a keyword that indicates the contents of an image has been described.

### 2-3. Application Examples

There are various application examples of the tablet terminal 1 according to an embodiment of the present disclosure. Thus, application examples of the tablet terminal 1 according to an embodiment of the present disclosure will now be described.

### Application Example 1

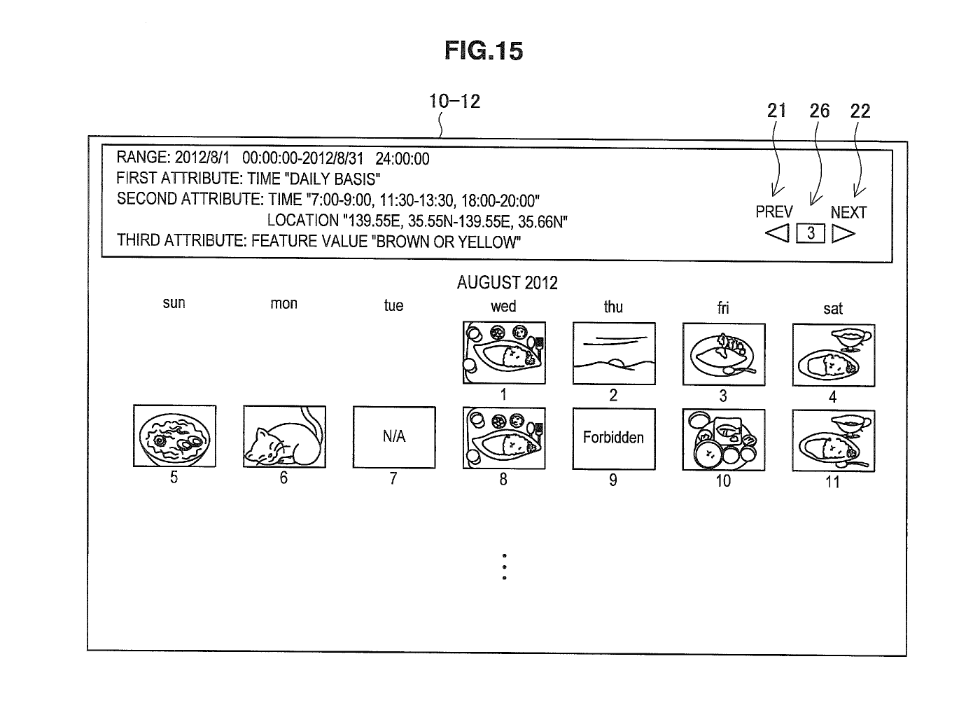

Initially, referring to FIG. 15, Application Example 1 of the tablet terminal 1 according to an embodiment of the present disclosure will be described. FIG. 15 is a diagram illustrating an example of a list view screen of the tablet terminal 1 according to Application Example 1. As shown in FIG. 15, the tablet terminal 1 displays a list view screen 10-12 indicating thumbnails of an image that corresponds to the specified imaging time and imaging location and has a larger number of feature values of brown or yellow color in a calendar form. In the list view screen 10-12, a ranking display column 26 indicating the order of selection specified by the user is provided. In addition, the list view screen 10-12 displays an image ranked on 3th place in the order of selection on a daily basis.

In the example shown in FIG. 15, the time “daily basis” is specified as the first attribute. In addition, the periods of time “07:00-09:00, 11:00-13:00, and 18:00-20:00” that are meal time slots are specified as the second attribute. Further, the geographical range “139.55E (east longitude), 35.55N (north latitude)-139.55E, 35.66N” identified by using latitude and longitude coordinates is specified as the second attribute. Moreover, the feature value “brown or yellow” is specified as the third attribute. In addition, the third rank in the order of selection is specified as the attribute value of the third attribute.

In a case where the user wants to find an image of curry, the user allows an image that is more likely to be the curry captured in a region where there is a restaurant at the meal time slot to be displayed as a list view by specifying each of the attributes described above. In addition, the user can update the list view by operating the PREV key 21 or the NEXT key 22 so that an image currently being displayed as thumbnails may be switched to an image having a higher or lower possibility of being the curry than the image currently being displayed as thumbnails. More specifically, the user can switch an image currently being displayed as thumbnails to an image having a larger number of pixels of brown or yellow that is the third attribute than an image currently being displayed as thumbnails by operating the PREV key 21. In addition, the user can switch an image currently being displayed as thumbnails to an image having a smaller number of pixels of brown or yellow that is the third attribute than the image currently being displayed as thumbnails by operating the NEXT key 22. In this way, the user can easily find a desired image while updating a list view.

Furthermore, in FIG. 15, thumbnails of curry are arranged on Wednesdays, August 1 and 8 and on Saturdays, August 4 and 11, and thus it can be found that the user eats curry regularly on Wednesday and Saturday. In this way, it is also possible for the user to recognize the periodicity of action of the user himself/herself by causing thumbnails to be displayed as a list view.

Application Example 1 has been described in the above.

### Application Example 2

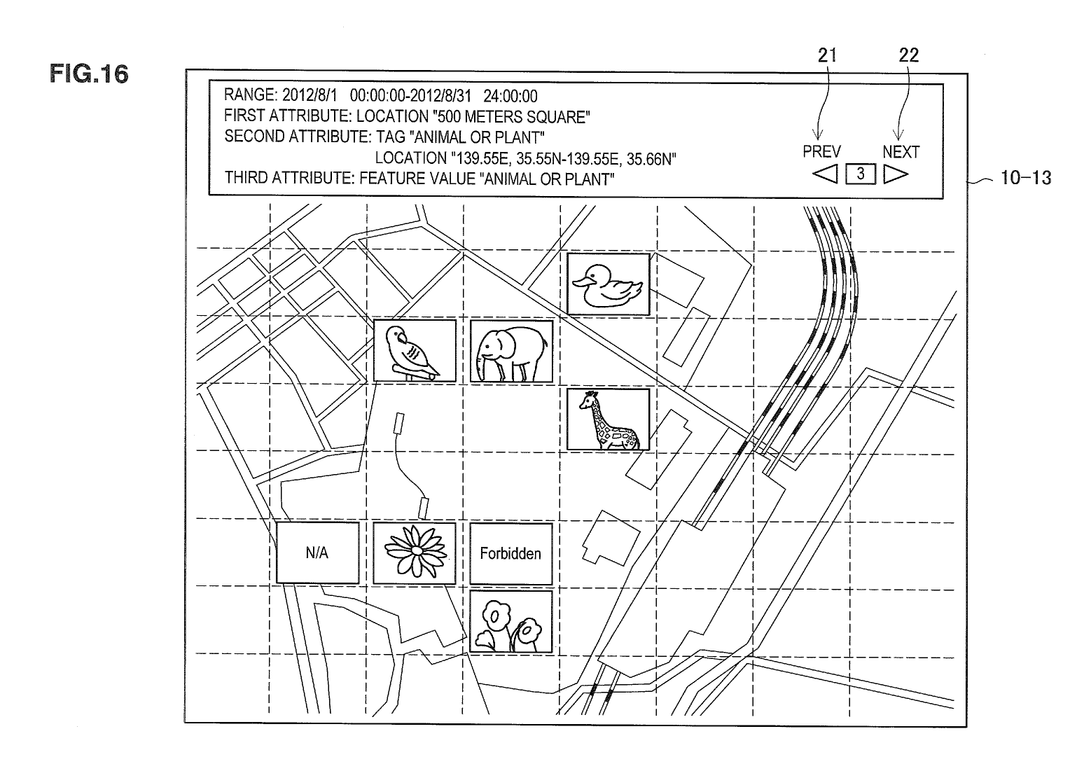

Subsequently, referring to FIG. 16, Application Example 2 of the tablet terminal 1 according to an embodiment of the present disclosure will be described. FIG. 16 is a diagram illustrating an example of a list view screen of the tablet terminal 1 according to Application Example 2. As shown in FIG. 16, the tablet terminal 1 displays a list view screen 10-13 in which thumbnails of an image that is tagged with “animal” or “plant” and has a larger number of feature values as an animal or plant are displayed on a map image. In the list view screen 10-13, a map image indicating a zoo is divided into a grid of five hundred meters square and the thumbnails are each arranged in a grid indicating a corresponding imaging location.

In the example shown in FIG. 16, the location “five hundred meters square” is specified as the first attribute. In addition, the tag “animal or plant” is specified as the second attribute. Further, the geographical range where the zoo is located “139.55E, 35.55N-139.55E, 35.66N” is specified as the second attribute. Moreover, the feature value “animal or plant” is specified as the third attribute. In addition, the third rank in the order of selection is specified as the attribute value of the third attribute.

In a case where the user wants to find an image of the giraffe captured at the zoo, the user allows an image that has a high probability of being the giraffe and that has a larger number of feature values as an animal or plant to be displayed as a list view on the map image by specifying each of the attributes described above. In addition, the user can update the list view by operating the PREV key 21 or the NEXT key 22 so that an image currently being displayed as thumbnails may be switched in an image having a higher or lower possibility of being the giraffe than the image currently being displayed as thumbnails. In this way, the user can easily find a desired image while updating the list view.

Application Example 2 has been described in the above.

### Application Example 3

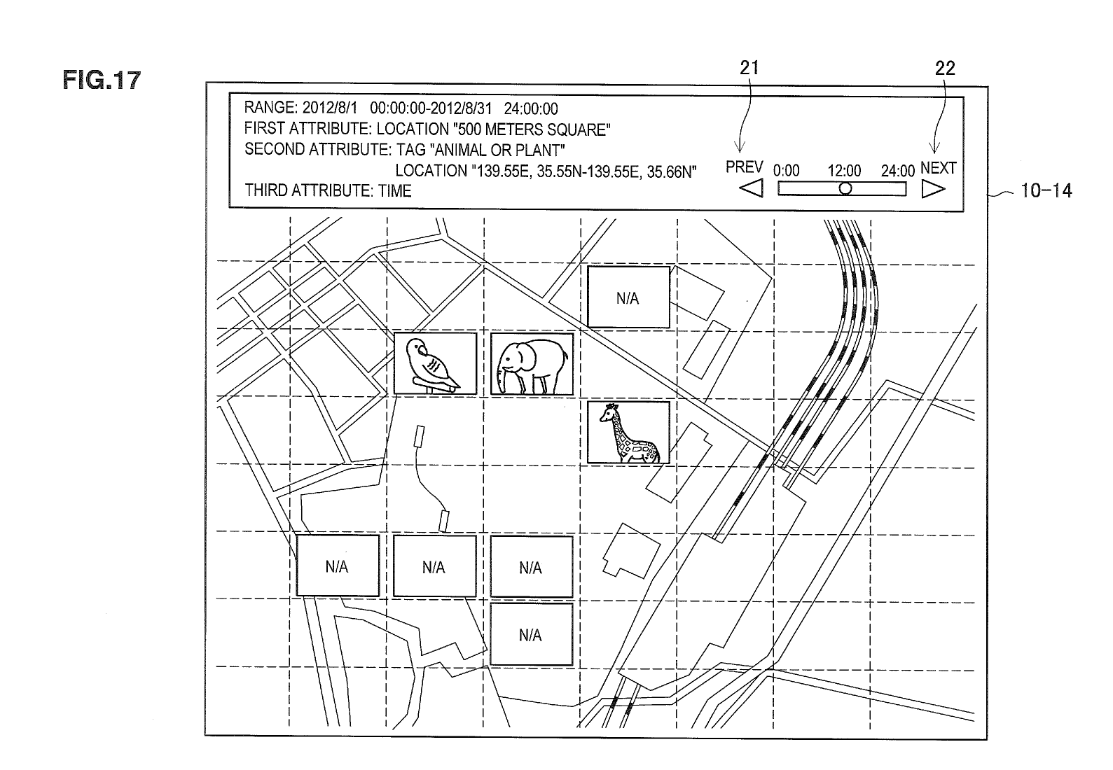

Subsequently, referring to FIG. 17, Application Example 3 of the tablet terminal 1 according to an embodiment of the present disclosure will be described. FIG. 17 is a diagram illustrating an example of a list view screen of the tablet terminal 1 according to Application Example 3. As shown in FIG. 17, the tablet terminal 1 displays a list view screen 10-14 in which thumbnails indicating an image that is tagged with “animal” or “plant” and is captured around the time of 12:00 are displayed on a map image. In this application example, unlike the list view screen 10-13 (see FIG. 16) shown in Application Example 2 described above, even when there is an image having a higher possibility of being the giraffe, a thumbnail marked “N/A” (not available) may be arranged in the image depending on the imaging time.

In the example shown in FIG. 17, the location “five hundred meters square” is specified as the first attribute. In addition, the tag “animal or plant” is specified as the second attribute. Further, the geographical range where the zoo is located “139.55E, 35.55N-139.55E, 35.66N” is specified as the second attribute. Moreover, the time is specified as the third attribute, and the time of 12:00 is specified as the attribute value of the third attribute.

In a case where the user wants to find an image of the giraffe, the user allows an image that has a high probability of being the giraffe and is captured around the specified time to be displayed as a list view on the map image by specifying each of the attributes described above. In addition, the user can update the list view by operating the PREV key 21 or the NEXT key 22 so that an image currently being displayed as thumbnails may be switched to an image that has a high possibility of being the giraffe and is captured at the time preceding or following the image currently being displayed as thumbnails.

Furthermore, in this application example, as shown in FIG. 17, even when there is an image having a higher possibility of being the giraffe, the image is not displayed as a thumbnails, and a thumbnail marked “N/A” (not available) is displayed in the image depending on the imaging time. Only the image captured around the specified time is displayed in the place corresponding to the imaging location as a thumbnail, and thus the user can recognize the position stayed at the specified time. The user can recognize the position stayed at the preceding or following time, that is, the moving route by advancing or delaying the time to be specified by operating the PREV key 21 or the NEXT key 22. Thus, the user can find a desired image, for example, while referring to his memories associated with a moving route such as having seen the giraffe and then the elephant in the northwest of the giraffe.

Application Example 3 has been described in the above.

### Application Example 4

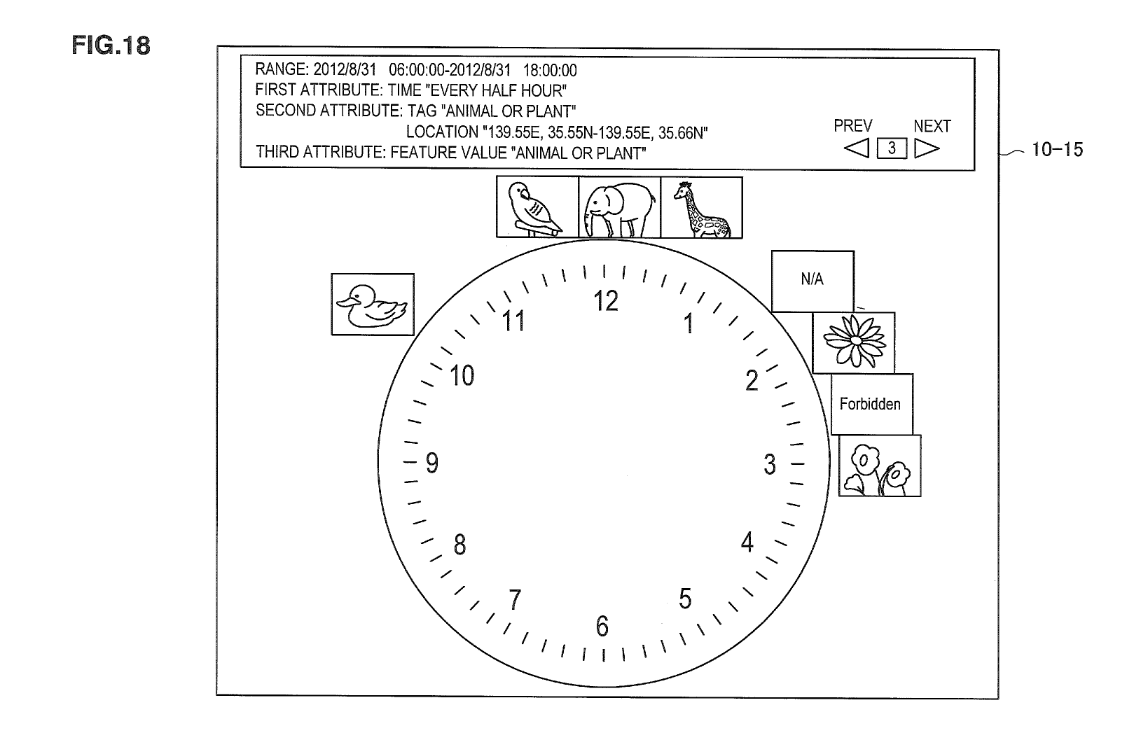

Subsequently, referring to FIG. 18, Application Example 4 of the tablet terminal 1 according to an embodiment of the present disclosure will be described. FIG. 18 is a diagram illustrating an example of a list view screen of the tablet terminal 1 according to Application Example 4. As shown in FIG. 18, the tablet terminal 1 displays a list view screen 10-15 in which thumbnails of an image that is tagged with “animal” or “plant” and has a larger number of feature values as an animal or plat to be displayed on the clock face. The images are grouped every half hour, and are each arranged in a position corresponding to the imaging time.

In the example shown in FIG. 18, the time “every half hour” is specified as the first attribute. In addition, the tag “animal or plant” is specified as the second attribute. Further, the geographical range “139.55E, 35.55N-139.55E, 35.66N” is specified as the second attribute. Moreover, the feature value “animal or plant” is specified as the third attribute. In addition, the third rank in the order of selection is specified as the attribute value of the third attribute.

In a case where the user wants to find an image of the giraffe, the user allows an image that has a larger number of feature values as an animal or plant and has a high probability of being the giraffe to be displayed as a list view on a background image indicating the clock face by specifying each of the attributes described above. As shown in FIG. 18, the image is arranged on the clock face, and thus it is possible for the user to find a desired image while recognizing the lapse of time along the dial.

In the above, Application Example 4 has been described.

### 3. Summary

In accordance with the embodiments of the present disclosure described above, it is possible to classify content data based on an attribute, to select an image having a high possibility of being the image desired by the user for each classification, and to generate a list view screen in which thumbnails indicating the selected image as a list view. Accordingly, it is possible for the user to find out a desired image at a glance from among thumbnails displayed as a list view.

Moreover, the tablet terminal 1 can arrange an image in various layouts such as the arrangement of a calendar form, the arrangement in a grid of a map image, and the arrangement on the dial, as the layout corresponding to the first attribute. Accordingly, it is possible for the user to find a desired image while remembering the memories along with the layout corresponding to the first attribute.

Furthermore, the tablet terminal 1 can switch thumbnails at once in response to the user operation. In this case, thumbnails to be switched are images having a high possibility of being an image desired by the user according to the order of selection based on the second and third attributes. Accordingly, it is possible for the user to find out a desired image while switching the list view of thumbnails to another.

Although preferred embodiments of the present disclosure have been described in detail with reference to the accompanying drawings, the technical scope of the present disclosure is not limited thereto. It will be understood by those skilled in the art that various changes and modifications of the above embodiments may be made. It is to be clearly understood that embodiments of the present disclosure to which such changes and modifications have been made are encompassed by the technical scope of the present disclosure defined by the appended claims.

For example, in the embodiments described above, it has been described that a desired image can be accessed, but the present disclosure is not limited to these embodiments. In accordance with another embodiment, the tablet terminal 1 is available to display a plurality of images desired by the user in a list view. For example, the user can easily look back on the travel memories by specifying the geographical range of the travel destination and displaying an image such as an image having the high frequency of a smiling face, an image in which his family member is captured, or the like, on a map image in a list view. Further, the user can tag a means of transportation and specify and the geographical range of a travel destination and the tag of a means of transportation, thereby it is possible to view the landscape view from a moving car or plane at once separately. Moreover, the user can tag a type of travel such as a guided tour, a package tour, a company trip, or the like; thereby it is possible to view an image for each type of these travels at once.

Furthermore, it is possible to create a computer program that causes hardware such as CPU, ROM, and RAM incorporated into the information processing device to perform a function equivalent to that of each element of the tablet terminal 1. In addition, a storage medium having such a computer program stored therein may also be provided.

Additionally, the present technology may also be configured as below.

(1) An information processing device including:

a classification unit configured to classify content data into any of a plurality of classification items based on a first attribute;

a priority level determination unit configured to determine a priority level to the content data classified by the classification unit for each of the classification items based on a second attribute;

a selection unit configured to select one of the content data for each of the classification items according to the priority level determined by the priority level determination unit based on a third attribute; and

a generation unit configured to generate a display image having a symbol image arranged therein, the symbol image being corresponded to the content data selected by the selection unit and being arranged in the display image for each of the classification items in a layout according to the first attribute.

(2) The information processing device according to (1), further including:

an input unit,

wherein the selection unit, when the input unit receives an input for changing an attribute value of the third attribute, reselects one of the content data for each of the classification items according to the priority level based on a changed attribute value of the third attribute, and

wherein the generation unit regenerates the display image by using the content data reselected by the selection unit.

(3) The information processing device according to (1) or (2),

wherein the first attribute is position information, and

wherein the generation unit generates a display image in which the symbol image is arranged in a position corresponding to a position where the content data on a background image representing a map is obtained.

(4) The information processing device according to any one of (1) to (3), wherein the generation unit arranges none of symbol images for the classification item in which none of the content data is classified.
(5) The information processing device according to any one of (1) to (4), wherein the selection unit selects one of the content data from content data having a higher priority level than a threshold based on the third attribute.
(6) The information processing device according to (5), wherein the generation unit arranges the symbol image indicating that there is no corresponding content data for the classification item in which the content data having the higher priority level than the threshold is not classified.
(7) The information processing device according to any one of (1) to (5), wherein the generation unit arranges the symbol image indicating that there is no corresponding content data for the classification item in which content data corresponding to an attribute value of the third attribute is not classified.
(8) The information processing device according to any one of (1) to (7), further including:

an input unit,

wherein the selection unit, when the input unit receives an input for changing an attribute value of the third attribute for one of the content data, reselects one of the content data from the content data classified in the classification item to which the content data is belonging, according to the priority level, based on a changed attribute value of the third attribute, and

wherein the generation unit regenerates the display image by using the content data reselected by the selection unit.

(9) The information processing device according to any one of (1) to (8), further including:

a setting unit configured to set browsing prohibition for the content data,

wherein the generation unit, when browsing of the content data selected by the selection unit is prohibited, arranges a symbol image indicating that browsing of the content data is prohibited, instead of a symbol image corresponding to the content data arranged in the display image.

(10) The information processing device according to any one of (1) to (9),

wherein the first attribute is time,

wherein the generation unit generates a display image in which the symbol image is arranged in a position corresponding to a date when the content data on a background image representing a calendar is obtained.

(11) The information processing device according to any one of (1) to (10),

wherein the first attribute is time,

wherein the generation unit generates a display image in which the symbol image is arranged in a position corresponding to a time when the content data on a background image representing a clock face is obtained.

(12) The information processing device according to any one of (1) to (11),

wherein the second attribute is a keyword,

wherein the priority level determination unit determines the priority level based on a keyword associated with the content data.

(13) The information processing device according to any one of (1) to (12),

wherein the third attribute is time,

wherein the selection unit selects the content data obtained at a time or around the time indicated by an attribute value of the third attribute for each of the classification items according to the priority level.

(14) The information processing device according to any one of (1) to (13),

wherein the third attribute is a feature value of an image,

wherein the selection unit selects the content data having a feature value indicated by an attribute value of the third attribute for each of the classification items according to the priority level.

(15) A non-transitory computer-readable storage medium having a program stored therein, the program causing a computer to execute:

classifying content data into any of a plurality of classification items based on a first attribute;

determining a priority level to the classified content data for each of the classification items based on a second attribute;

selecting one of the content data for each of the classification items according to the priority level based on a third attribute; and

generating a display image having a symbol image arranged therein, the symbol image being corresponded to the selected content data and being arranged in the display image for each of the classification items in a layout according to the first attribute.

What is claimed is:

1. An information processing device comprising:
a classification unit configured to classify content data into any of a plurality of classification items based on a first attribute;
a priority level determination unit configured to determine a priority level to the content data classified by the classification unit for each of the classification items based on a second attribute;
a selection unit configured to select one of the content data for each of the classification items according to the priority level determined by the priority level determination unit based on a third attribute; and
a generation unit configured to generate a display image having a symbol image arranged therein, the symbol image being corresponded to the content data selected by the selection unit and being arranged in the display image for each of the classification items in a layout according to the first attribute.

2. The information processing device according to claim 1, further comprising:
an input unit,
wherein the selection unit, when the input unit receives an input for changing an attribute value of the third attribute, reselects one of the content data for each of the classification items according to the priority level based on a changed attribute value of the third attribute, and
wherein the generation unit regenerates the display image by using the content data reselected by the selection unit.

3. The information processing device according to claim 1,
wherein the first attribute is position information, and
wherein the generation unit generates a display image in which the symbol image is arranged in a position corresponding to a position where the content data on a background image representing a map is obtained.

4. The information processing device according to claim 1, wherein the generation unit arranges none of symbol images for the classification item in which none of the content data is classified.

5. The information processing device according to claim 1, wherein the selection unit selects one of the content data from content data having a higher priority level than a threshold based on the third attribute.

6. The information processing device according to claim 5, wherein the generation unit arranges the symbol image indicating that there is no corresponding content data for the classification item in which the content data having the higher priority level than the threshold is not classified.

7. The information processing device according to claim 1, wherein the generation unit arranges the symbol image indicating that there is no corresponding content data for the classification item in which content data corresponding to an attribute value of the third attribute is not classified.

8. The information processing device according to claim 1, further comprising:
an input unit,
wherein the selection unit, when the input unit receives an input for changing an attribute value of the third attribute for one of the content data, reselects one of the content data from the content data classified in the classification item to which the content data is belonging, according to the priority level, based on a changed attribute value of the third attribute, and
wherein the generation unit regenerates the display image by using the content data reselected by the selection unit.

9. The information processing device according to claim 1, further comprising:
a setting unit configured to set browsing prohibition for the content data,
wherein the generation unit, when browsing of the content data selected by the selection unit is prohibited, arranges a symbol image indicating that browsing of the content data is prohibited, instead of a symbol image corresponding to the content data arranged in the display image.

10. The information processing device according to claim 1,
wherein the first attribute is time,
wherein the generation unit generates a display image in which the symbol image is arranged in a position corresponding to a date when the content data on a background image representing a calendar is obtained.

11. The information processing device according to claim 1,
wherein the first attribute is time,
wherein the generation unit generates a display image in which the symbol image is arranged in a position corresponding to a time when the content data on a background image representing a clock face is obtained.

12. The information processing device according to claim 1,
wherein the second attribute is a keyword,
wherein the priority level determination unit determines the priority level based on a keyword associated with the content data.

13. The information processing device according to claim 1,
wherein the third attribute is time,
wherein the selection unit selects the content data obtained at a time or around the time indicated by an attribute value of the third attribute for each of the classification items according to the priority level.

14. The information processing device according to claim 1,
wherein the third attribute is a feature value of an image,
wherein the selection unit selects the content data having a feature value indicated by an attribute value of the third attribute for each of the classification items according to the priority level.

15. A non-transitory computer-readable storage medium having a program stored therein, the program causing a computer to execute:
classifying content data into any of a plurality of classification items based on a first attribute;
determining a priority level to the classified content data for each of the classification items based on a second attribute;
selecting one of the content data for each of the classification items according to the priority level based on a third attribute; and
generating a display image having a symbol image arranged therein, the symbol image being corresponded to the selected content data and being arranged in the display image for each of the classification items in a layout according to the first attribute.
